(19) United States
(12) Patent Application Publication
(10) Pub. No.: US 2008/0306809 A1
(43) Pub. Date: Dec. 11, 2008

(54) METHOD AND SYSTEM FOR PROVIDING SPONSOR MATCH ADVERTISEMENT SERVICE

(75) Inventors: Dong Su Kwak, Yongin-Si (KR); Young Cheol Han, Seoul (KR); Jin Hwan Kim, Seoul (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WIPIA CO., LTD., Seoul (KR)

(21) Appl. No.: 11/857,542

(22) Filed: Sep. 19, 2007

(30) Foreign Application Priority Data
Jun. 5, 2007 (KR) 10-2007-0055186

(51) Int. Cl. G06Q 30/00; G06Q 10/00

(52) U.S. Cl. 705/10; 705/14

(57) ABSTRACT

The present invention relates to a method and system for providing a sponsor match advertisement service which, when a service user sets a sponsored tag and sponsored tag related additional information of advertising information, which is highly related to or identical to a user created content (UCC), registers the sponsored tag and sponsored tag related additional information with the content, and when a service visitor clicks the sponsored tag, may provide advertising information of a sponsor which is mapped to the sponsored tag and may provide a portion of an advertising revenue to the service user.

### CROSS-REFERENCE TO RELATED APPLICATION

This application claims the benefit of Korean Patent Application No. 10-2007-0055186, filed on Jun. 5, 2007, in the Korean Intellectual Property Office, the disclosure of which is incorporated herein by reference.

### BACKGROUND OF THE INVENTION

1. Field of the Invention

The present invention relates to a method and system for providing a sponsor match advertisement service. More particularly, the present invention relates to a method and system for providing a sponsor match advertisement service which, when a service user registers contents, may provide the service user with advertisement information which corresponds to or is highly related to the contents by setting a sponsored tag, directly mapped to advertisement information of a particular advertiser, and may cause a sponsorship marketing effect and purchase of the service user based on a service participation by distributing a portion of advertising revenue to the service user.

2. Description of Related Art

Generally, in Internet advertising in a conventional art, contents of text-based websites, that is, websites where an advertising exposure may be made, are analyzed and most highly related keywords are extracted using a keyword or context extraction engines. Accordingly, advertisements matching corresponding keywords are displayed on websites.

In such a method, although an accuracy of the analyzing and matching may vary depending on a performance of extraction engine, software engines may not exactly understand meaning or context of contents. Accordingly, accurate keyword information may not be retrieved. Also, such a method may not be applied to multimedia-based contents such as videos, since particular keywords or contexts may not be extracted from the multimedia-based contents.

In another method of Internet advertising in a conventional art, service users or service providers select advertisements suitable for characteristics of websites, and provide advertisements of sponsors to websites such as blogs. In such a method, when service users or service providers select a content category suitable for characteristics of corresponding websites from predetermined content category tables, the service users or service providers provide advertisement information of sponsors corresponding to the content category. The method of extracting advertisement information based on predetermined content category tables may be applied to advertisement matching associated with sports, fashion, movies, and the like. However, the method may not be applied to advertisement matching associated with particular brands, products, services such as Nike, Nike shoes, Christian Dior sunglasses, the film “Spider-man”, and the like.

Thus, a content matching advertisement exposure model which is applicable to a multimedia-based user created content (UCC) such as videos and is able to provide advertisement information which accurately matches particular brands, products, and services, is required. In this instance, content matching advertisement may not be applied to the multimedia-based UCC using keywords or context extraction engines, and the advertisement information is associated with products or services identical to or highly related to corresponding contents. Also, an advertisement exposure model, which may provide service users with advertisement information accurately matching corresponding contents and enable service visitors or sponsors to achieve reliable advertisement exposures, is required to increase advertising effect more efficiently.

### BRIEF SUMMARY

The present invention provides a method and system for providing a sponsor match advertisement service which, when a service user registers a user created content (UCC), extracts advertisement information of a particular sponsor or a plurality of advertisement keywords highly related to a corresponding content from an advertisement information database of a pre-registered advertiser, performs a generation of a sponsored tag corresponding to the extracted advertisement information and setting of related additional information, when a service visitor clicks a sponsored tag exposed with contents, provides advertisement information of a sponsor corresponding to the sponsored tag, and thereby may create a sponsorship marketing effect of a sponsor based on participation of the service user.

The present invention also provides a method and system for providing a sponsor match advertisement service which may be applied to a multimedia-based UCC such as a video where a conventional content matching advertisement service may not be applied using a keyword or context extraction engine, provide advertisement information which is associated with a corresponding content and accurately matches with a particular brand, product, service, as well as a content category, match single advertisement information of a particular sponsor with a corresponding content, set a function to directly access a sub page including information about a particular product as well as to access to a main page, that is, an access to a main Uniform Resource Locator (URL) of an advertisement website registered by the advertiser, and thereby may create an advertising effect for a service visitor or sponsor more efficiently.

The present invention also provides a method and system for providing a sponsor match advertisement service which evaluates and estimates a reliability index of a sponsored tag which is set by a service user in association with a corresponding content, that is, a degree of association between the content and advertisement information, provides different advertising exposures of the sponsored tag according to the estimated index, and thereby may provide a service visitor with previous determining criteria for obtaining the advertisement information when clicking the sponsored tag, prevent the service visitor from receiving spam, and match the sponsored tag with reliable advertisement information more actively by setting advertisement information which is not associated with the content.

According to an aspect of the present invention, there is provided a method of providing an Internet advertisement associated with an Internet content, the method including: maintaining a database which stores user information of a service user, at least one content uploaded by the service user, and a sponsored tag corresponding to the at least one content; receiving a predetermined content from the service user; receiving a sponsored tag corresponding to the content from the service user; storing the sponsored tag and the content received in the database; and providing a service visitor with predetermined advertising information corresponding to the sponsored tag, when receiving an input with respect to the sponsored tag from the service visitor viewing the content.

### BRIEF DESCRIPTION OF THE DRAWINGS

The above and/or other aspects and advantages of the present invention will become apparent and more readily appreciated from the following detailed description, taken in conjunction with the accompanying drawings of which:

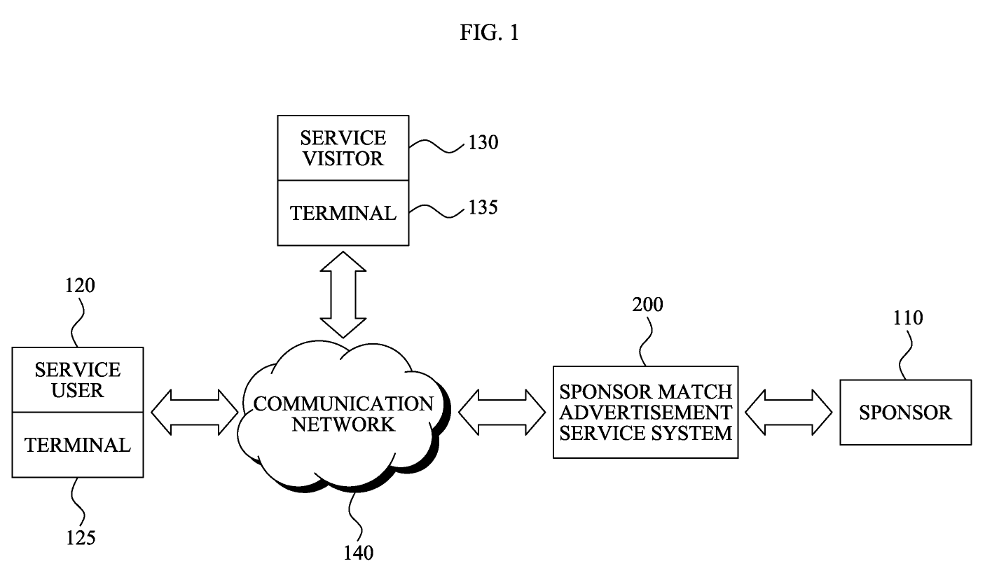

a.) FIG. 1 is a block diagram illustrating a sponsor match advertisement service system according to an embodiment of the present invention;

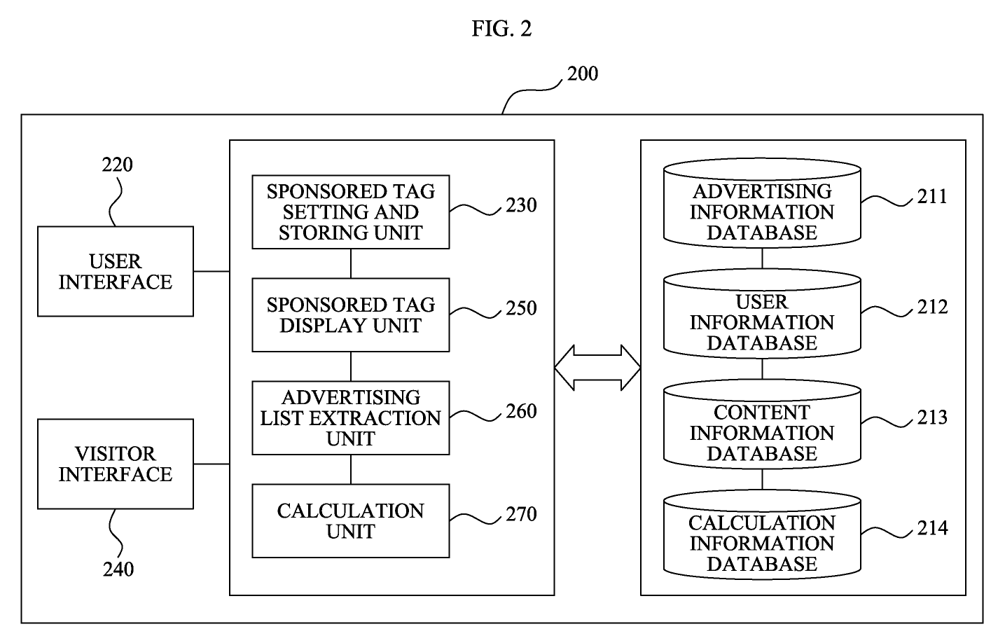

b.) FIG. 2 is a detailed block diagram illustrating the sponsor match advertisement service system of FIG. 1;

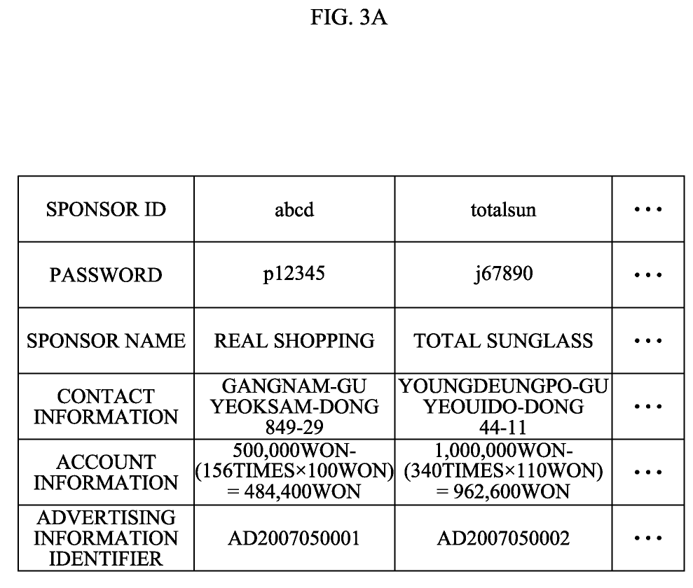

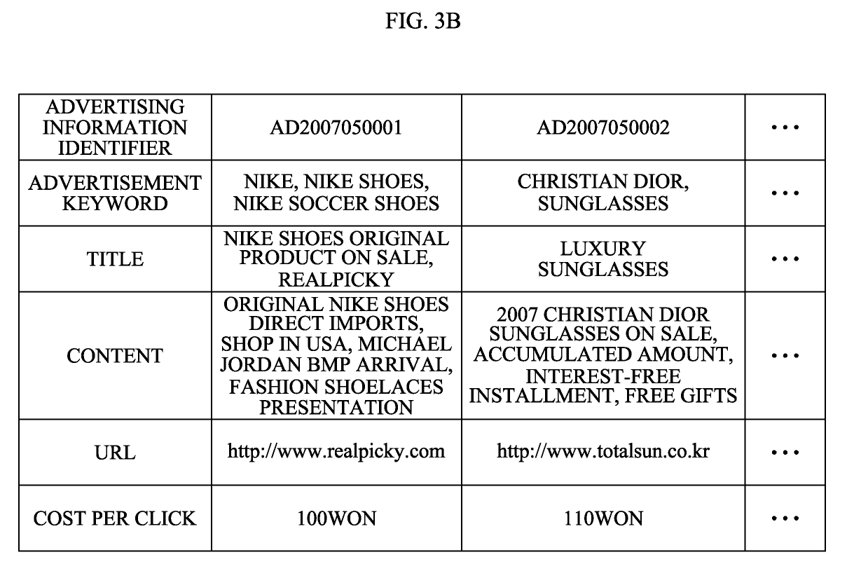

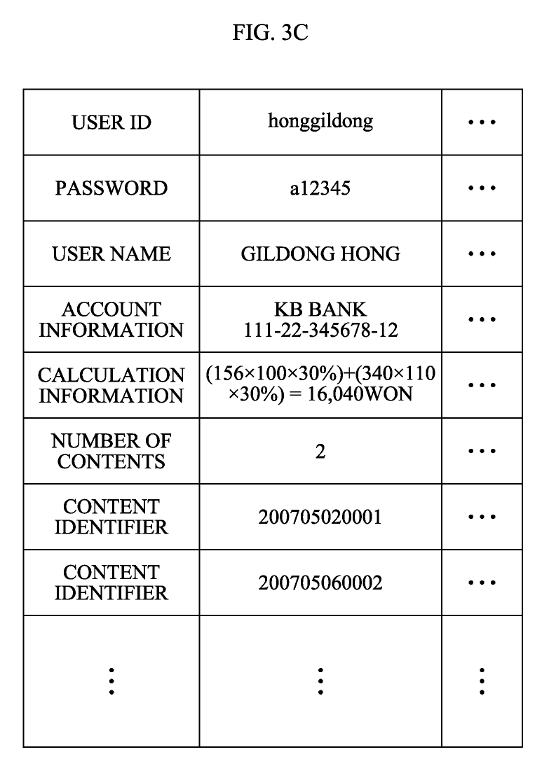

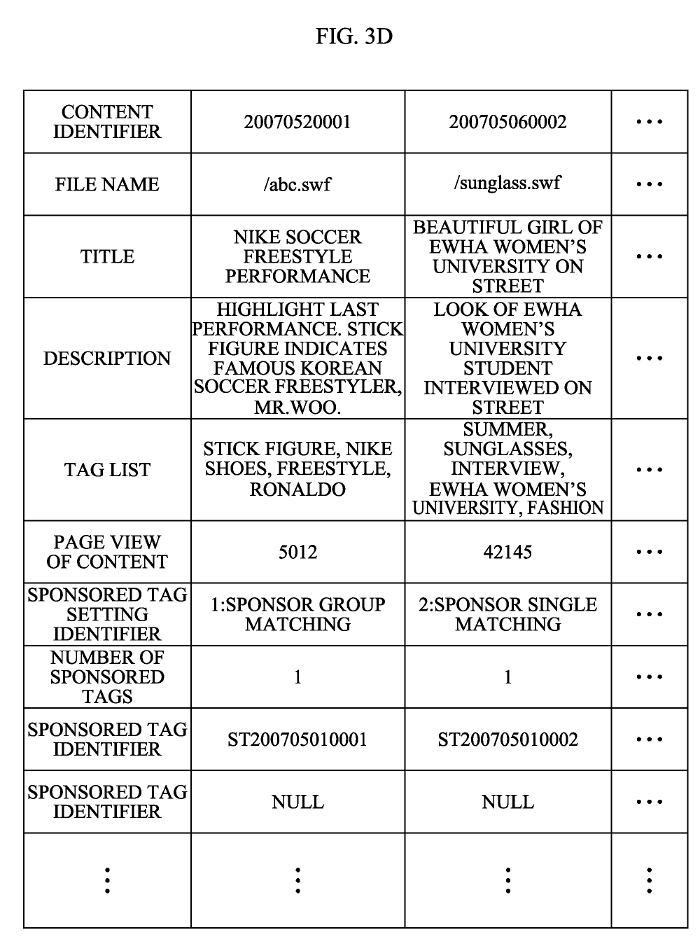

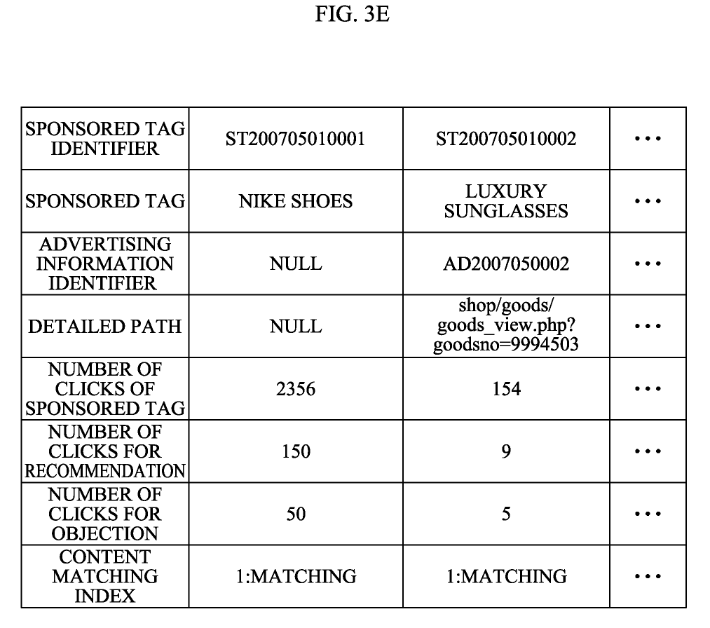

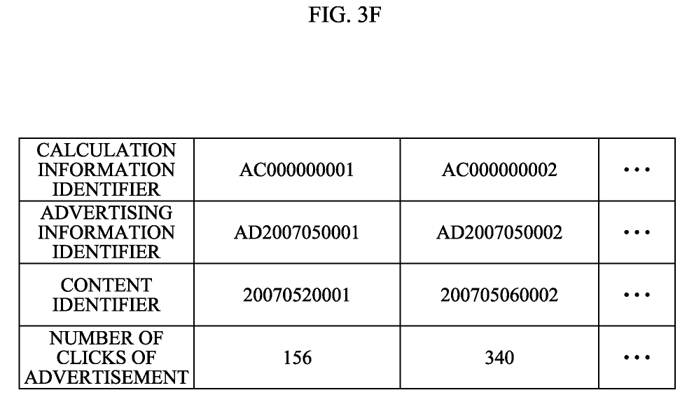

c.) FIGS. 3A and 3B illustrate configurations of advertisement information database according to the present invention;

d.) FIG. 3C illustrates a configuration of advertisement information database according to the present invention;

e.) FIGS. 3D through 3F illustrate configurations of content information database stored in interoperation with a user information database according to the present invention;

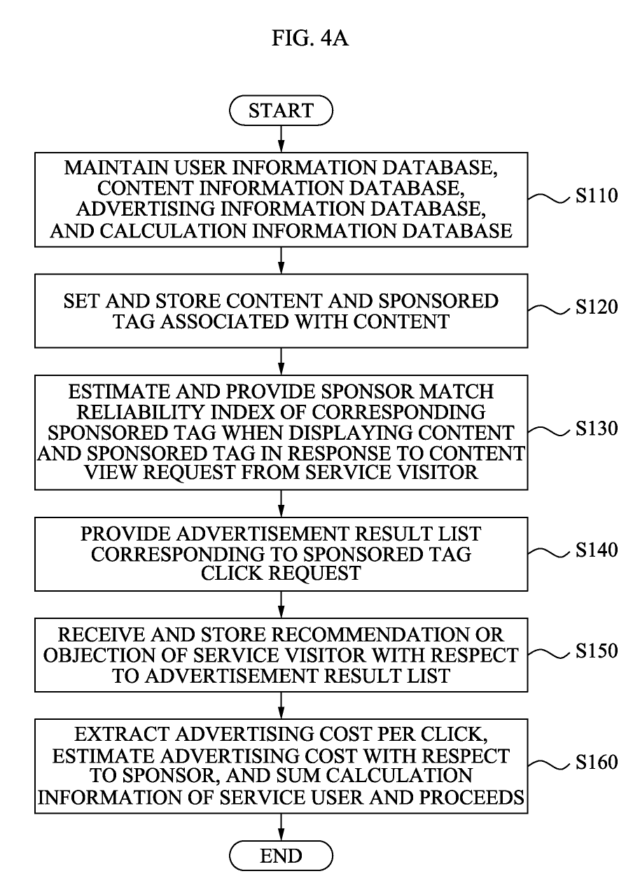

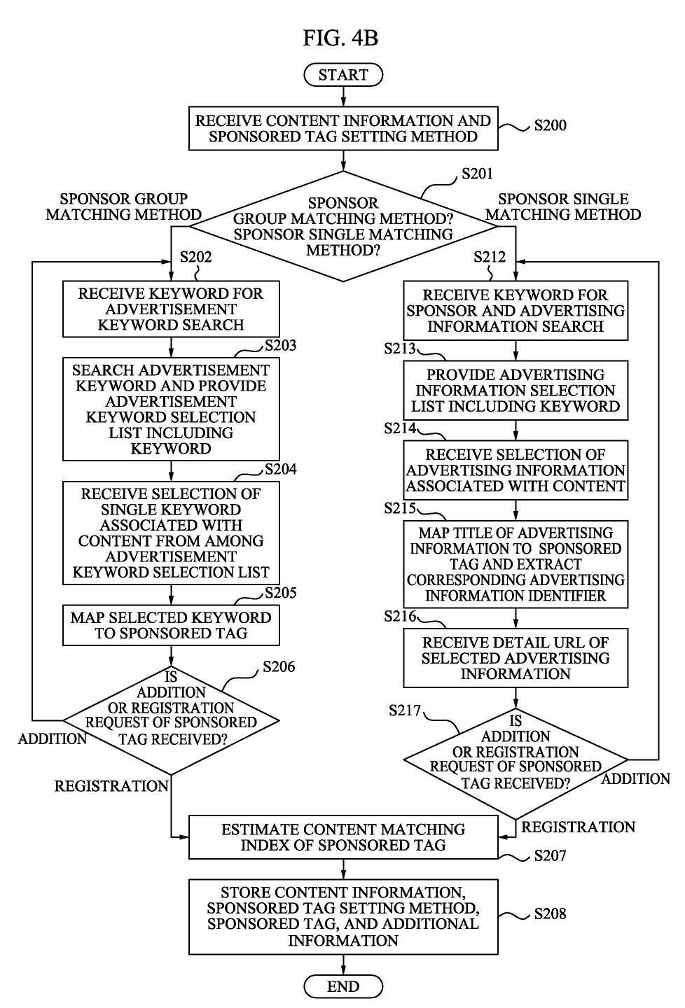

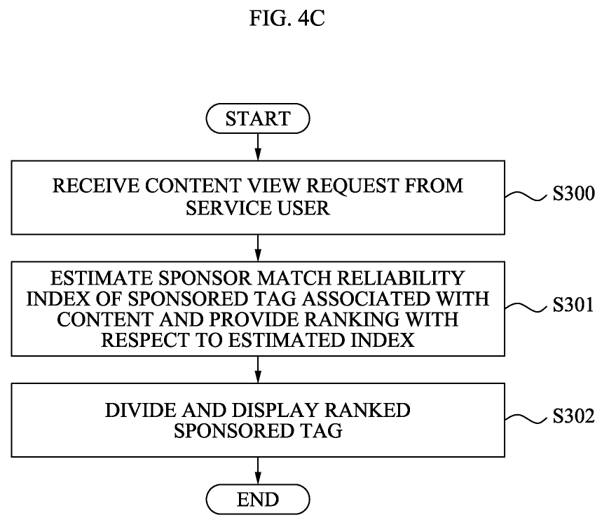

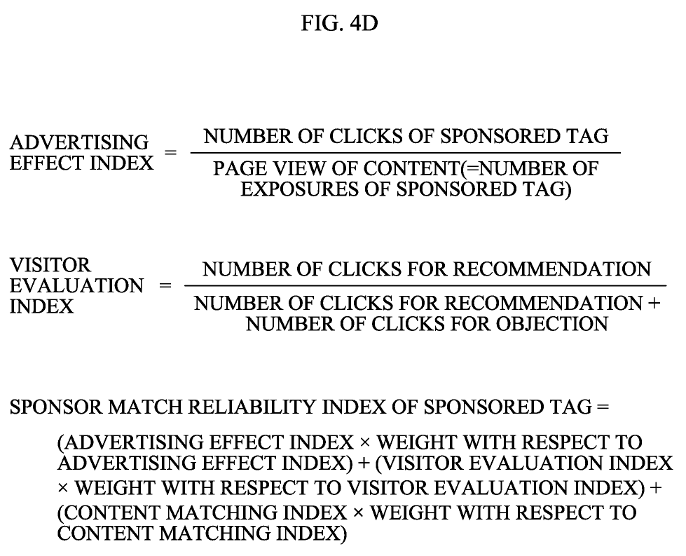

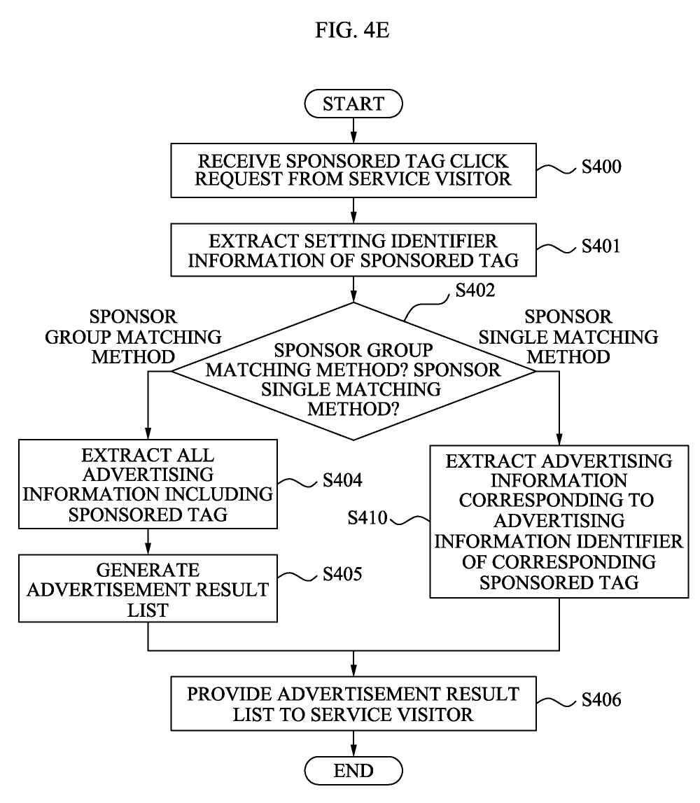

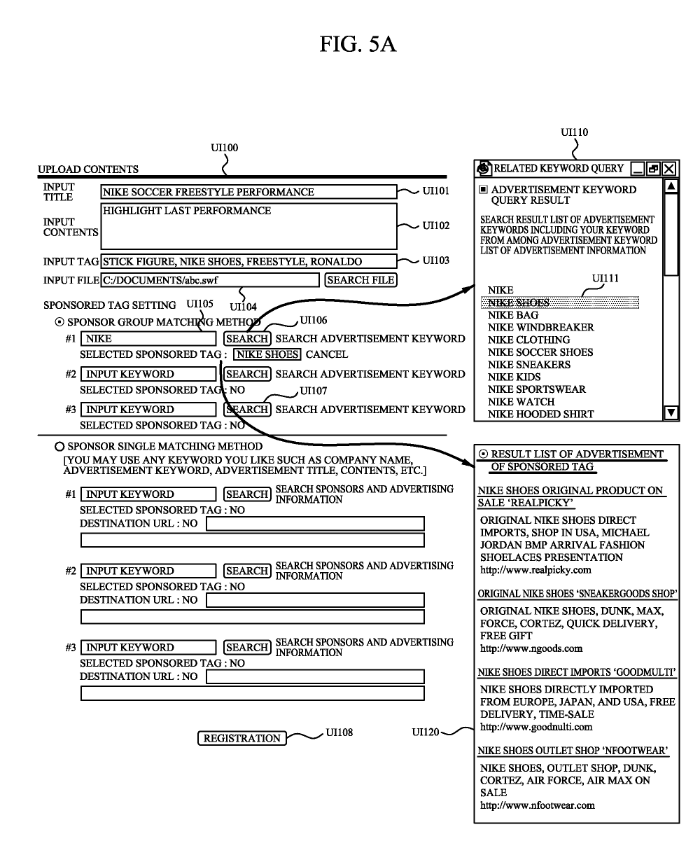

f.) FIG. 4A is a flowchart illustrating a method of providing a sponsor match advertisement service of a sponsor match advertisement service system according to an embodiment of the present invention;

g.) FIG. 4B is a flowchart illustrating an operation of setting and registering a sponsored tag according to an embodiment of the present invention;

h.) FIG. 4C is a flowchart illustrating an operation of displaying a content and a sponsored tag associated with the content according to an embodiment of the present invention;

i.) FIG. 4D illustrates examples of formulas for estimating a sponsor match reliability index of a sponsored tag according to the present invention;

j.) FIG. 4E is a flowchart illustrating an operation of providing an advertisement result list according to the present invention;

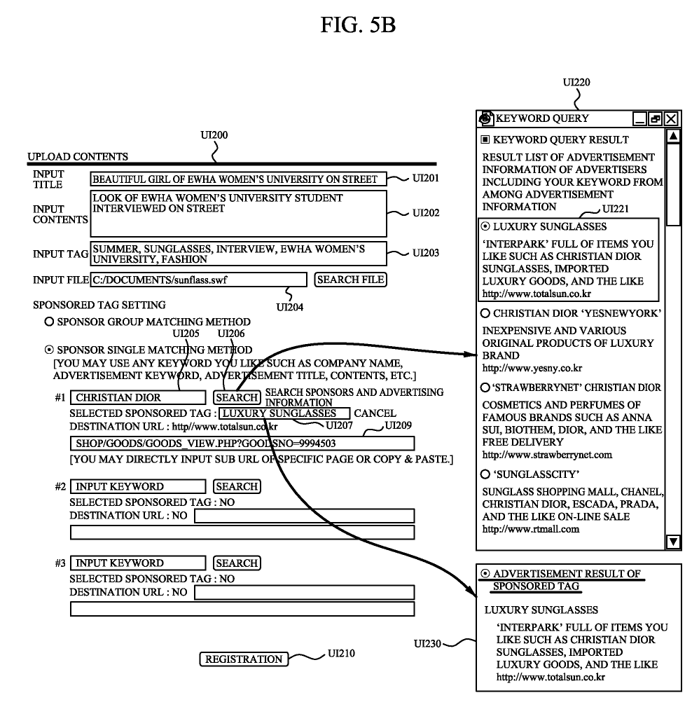

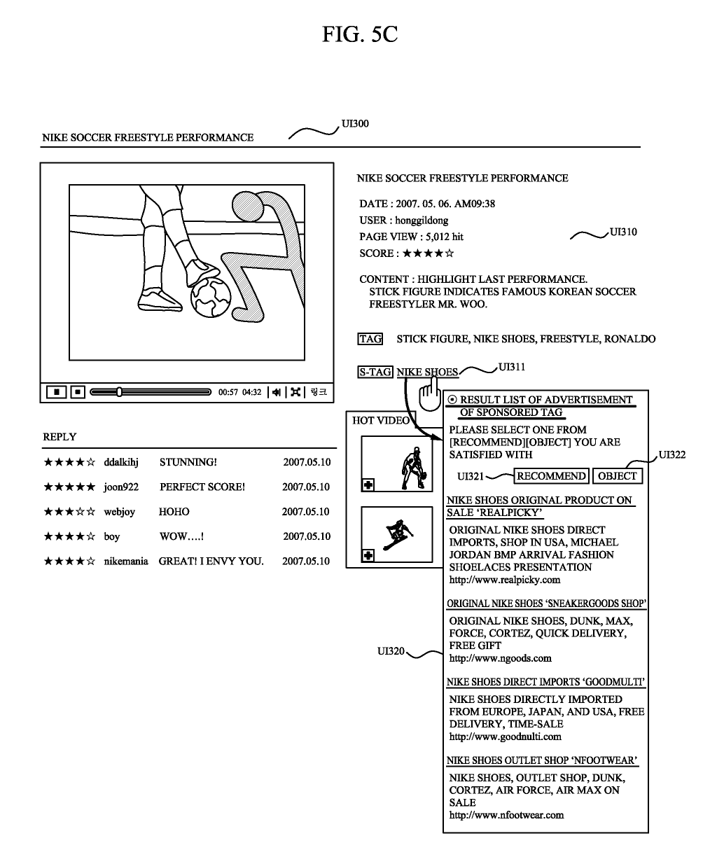

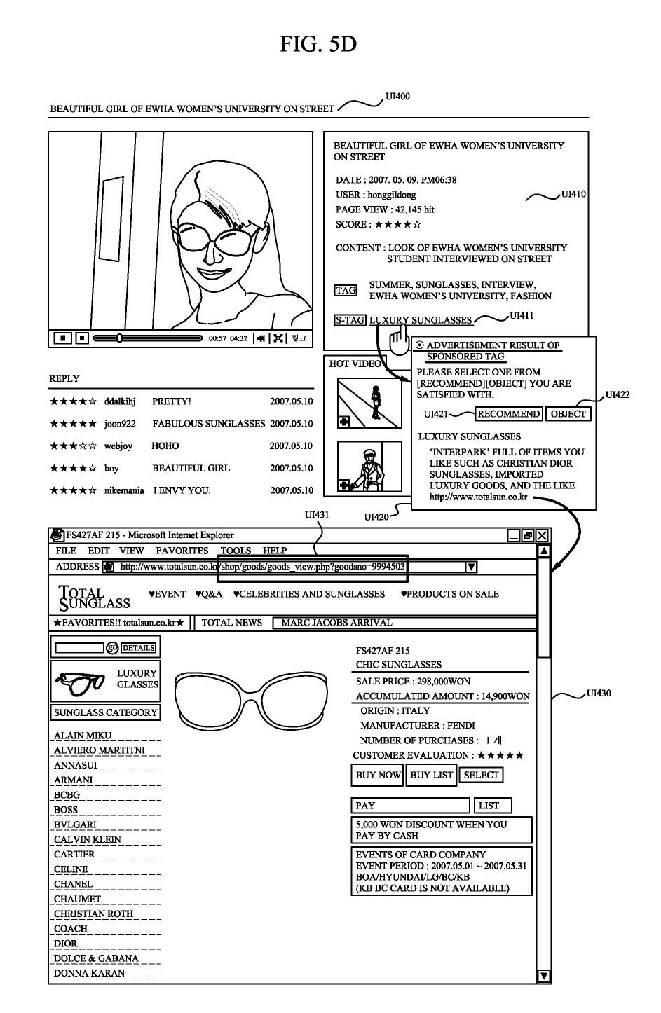

k.) FIGS. 5A and 5B illustrate examples of user interface for setting and registering a content and a sponsored tag associated with the content; and

l.) FIGS. 5C and 5D illustrate examples of user interface for providing content provided according to a service visitor request, an exposure of a sponsored tag associated with the content, and an advertisement result list.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

FIG. 1 is a block diagram illustrating a sponsor match advertisement service system according to an embodiment of the present invention. FIG. 2 is a detailed block diagram illustrating the sponsor match advertisement service system of FIG. 1.

A ‘sponsored tag’ throughout the present specification indicates an advertising slogan representing advertisement information which is identical to or highly related to a particular content. The sponsored tag is to provide a service visitor with the advertisement information by being matched with the corresponding content by a service user. When the service visitor clicks a corresponding advertising slogan, the advertisement information is displayed. The sponsored tag according to the present invention, that is, an advertising slogan representing particular advertisement information, varies according to a sponsored tag setting method selected when setting the sponsored tag by the service user. The sponsored tag may be an advertisement keyword extracted by the service user from an advertising information database 211 or an advertisement information title of a particular sponsor. Specifically, the sponsored tag indicates a tag which enables the service user to be connected to a particular advertisement website of a sponsor set by matching with the content by the service user.

FIG. 1 illustrates a configuration and network connection of a service visitor 130, a service user 120, and a sponsor match advertisement service system 200 performing a sponsor match advertisement service method according to the present invention. When the service user 120 registers a user created content (UCC), the sponsor match advertisement service system 200 inputs content information and sets a sponsored tag associated with the content information, and thereby may enable the content information, an advertisement keyword associated with the content information, or advertisement information of a sponsor 110 to be mapped to the content and registered. When a content view of the service visitor 130 is requested, the sponsor match advertisement service system 200 exposes the sponsored tag by dividing the content, registered by the service user 120 according to detailed information of the content and a sponsor match reliability index of the sponsored tag. In this instance, the sponsor match reliability index of the sponsored tag indicates a degree of association between the content and advertisement information. Also, the sponsor match advertisement service system 200 extracts an advertisement result list corresponding to a corresponding sponsored tag in response to a sponsored tag click request from the service visitor 130, and provides the advertisement result list to the service visitor 130.

The service user 120 utilizes a terminal 125 for connecting to the sponsor match advertisement service system 200. Also, the service user 120 may indicate an Internet user to provide the service visitor 130 with the content and advertisement information of a product or service, which is identical to or highly related to the content, by inputting content information and setting an associated sponsored tag through a user interface of the sponsor match advertisement service system 200.

The service visitor 130 possesses another terminal 135 for connecting to the sponsor match advertisement service system 200. Also, the service visitor 130 indicates an Internet user to confirm the content, registered by the service user 120, or to acquire the advertisement result list by a sponsored tag click request through a visitor interface of the sponsor match advertisement service system 200. In this instance, in the sponsored tag click request, the sponsored tag is exposed with a corresponding content. Here, the service visitor 130 may evaluate the sponsor match reliability by selecting a recommendation or objection with respect to the advertisement result list or advertising information exposed when requesting the sponsored tag click.

The terminals 125 and 135 receive information about a content registration from the service user 140, or response to the request for the content view from the service visitor 130 and the sponsored tag click request, while maintaining a connection with the sponsor match advertisement service system 200 via a communication network 140 such as the Internet. Accordingly, the terminals 125 and 135 display the content information, sponsored tag, and advertisement result list, provided from the sponsor match advertisement service system 200, on a display.

The sponsor 110 may indicate a content provider (CP) managing a website where a location on a network is designated by a network address, for example, an Internet Protocol (IP) address, Uniform Resource Locator (URL), domain, and the like. Also, the sponsor 110 enables an advertisement keyword or advertising information, associated with the sponsor 110, to be set as a sponsored tag by requesting a registration of a sponsor match advertisement using a particular advertisement keyword when the service user 120 sets the sponsored tag associated with the content. When the service visitor 130 requests the click of the sponsored tag exposed with the content, the sponsor 110 enables advertising information corresponding to the request to be provided. Also, when the service visitor 130 clicks the advertising information of the sponsor 110, the sponsor 110 may pay a predetermined advertising fee associated with the click to a system manager according to the present invention. Since the above-described advertising fee payment model is widely known, a detailed description of the advertising fee payment model is omitted.

Hereinafter, a detailed configuration of the sponsor match advertisement service system 200 is described with reference to FIG. 2.

Referring to FIG. 2, the sponsor match advertisement service system 200 includes an advertising information database 211, a user information database 212, a content information database 213, a calculation information database 214, a user interface 220, a sponsored tag setting and storing unit 230, a visitor interface 240, a sponsored tag display unit 250, an advertising list extraction unit 260, and a calculation unit 270.

Referring to FIGS. 3A and 3B, an advertising information database 211 stores sponsor information and advertising information about at least one individual advertisement associated with a sponsor 110. The sponsor information is registered by the sponsor 110. Specifically, the advertising information database 211 includes the sponsor information, stores and/or maintains information about at least one individual advertisement associated with the sponsor 110 in order to provide advertising information of the sponsor 110 using the sponsor match advertisement service system 200. The sponsor information and the information about the at least one individual advertisement are inputted by the sponsor 110 through joining membership, and includes, as an example a sponsor identification (ID), a password, a sponsor name, contact information, and account information for paying an advertising cost.

In this instance, the information about the at least one individual advertisement includes a title, a content, a route, that is, a Uniform Resource Locator (URL), at least one advertisement keyword, and a cost per click. The at least one advertisement keyword is inputted to enable a service user and the sponsor match advertisement service system 200 to easily retrieve and use related information.

Specifically, the cost per click, that is, a cost per advertisement click, corresponds to a result of the sponsor match advertisement service system 200 in response to a sponsored tag click request of the service visitor 130. Also, the cost per click may be a comparison standard for providing a priority of extraction when extracting an advertisement result list, and may be an advertising cost per click when the advertisement result list, provided to the service visitor 130, is selected by a command input device of the service visitor 130. The advertising cost per click is a fee the sponsor 110 requests to be paid.

The account information is information about a cost, incurred by the sponsor 110, of the advertising cost per click generated by the sponsor match advertisement service to be deducted. Also, the account information is updated every time the advertising cost is deducted, and stored in the advertising information database 211. Specifically, the account information is a numerical value of an amount held in a predetermined account of the sponsor 110, and a predetermined advertising cost is deducted when a displayed advertisement result list is selected by the service visitor 130. When a balance of the account information is less than a predetermined value, the sponsor match advertisement service system 200 may order the sponsor match advertisement service to stop or provide information requesting an additional charge with respect to an account balance.

The user information database 212 stores user information of the service user 120, a content registered by the service user 120, and information associated with the content. In this instance, the service user 120 is a member of the sponsor match advertisement service system 200. That is, referring to FIG. 3C, the user information database 212 stores and/or maintains a user ID, a password, a user name, account information, advertising revenue calculation information, information about a total number of registered content, and content identifier information. In this instance, the user ID, password, user name, account information, and advertising revenue calculation information are inputted by the service user 120. Also, the content identifier information and the information about the total number of registered content may refer to user content information which is registered by the service user 120 and stored in the content information database 213.

The content information database 213 interoperates with the user information database 212. The content information database 213 stores advertising mapping data, information associated with a sponsored tag setting, and information required to estimate the sponsor match reliability index of the sponsored tag. The advertising mapping data is automatically generated or extracted, when the service user 120 sets and registers content and the sponsored tag associated with the content, i.e. when setting content information and selectively setting at least one sponsored tag to the corresponding content. Also, the advertising mapping data is data including the sponsored tag and an advertising information identifier. The information associated with a sponsored tag setting includes a sub page path of an advertisement website, which is inputted by the service user 120. The information required to estimate the sponsor match reliability index of the sponsored tag includes information associated with a request for a corresponding content query by the service visitor 130, request for a sponsored tag click, request for selecting of a recommendation or objection with respect to the advertisement result list, and the like. The recommendation or objection with respect to the advertisement result list is exposed when requesting the sponsored tag click.

That is, referring to FIGS. 3D and 3E, the content information database 213 stores and maintains the information such as the title, content description, at least one tag, file name, sponsored tag which is automatically generated when setting the sponsored tag, sponsored tag setting identifier which is classified by the sponsored tag setting method, advertising information identifier which may retrieve particular advertising information mapped in association with the sponsored tag, content match index of the sponsored tag, sub page path of the advertisement website inputted by the service user 120, page views of the corresponding content by the service visitor 130, the number of clicks on the sponsored tag, the number of clicks on the recommendation or objection with respect to the advertisement result list which is exposed when requesting the sponsored tag click, and the like.

The sponsored tag which is automatically generated when setting the sponsored tag varies according to the sponsored tag setting method of the service user 120. Also, the sponsored tag may be a title of advertising information which may represent particular advertising information or any one of the advertisement keywords extracted from the advertising information database 211 registered by the sponsor 110 any one of the advertisement keywords extracted from the advertising information database 211 registered by the sponsor 110 and a title of advertising information which may represent particular advertising information. The sponsored tag identifier has a sponsor group tag or sponsor single tag value according the sponsored tag setting method.

Referring to FIG. 3F, the calculation information database 214 stores information associated with advertising cost calculation with respect to the sponsor 110 when the service visitor 130 clicks a particular advertisement, and information about an advertising revenue distribution calculation associated with the clicked advertisement with respect to the service user 120. That is, the calculation information database 214 uses the advertising information identifier and the content identifier as a key item, and includes a calculation information list for storing the advertising information identifier, the content identifier, and a number of clicks on an advertisement in order to store and maintain the number of clicks on the advertisement for each clicked advertising information.

In this instance, when the advertising information identifier and the content identifier of the calculation information list are used as a condition, the advertising cost per click, information about a corresponding sponsor, and user information may be retrieved from the advertising information database 211, user information database 212, and the content information database 213. The extracted advertising cost per click may be deducted from account information of the sponsor 110 corresponding to the advertising information. Also, according to the present invention, the advertising cost with respect to the sponsor 110 and the revenue distribution with respect to the service user 120 may be calculated in a way that calculation information of the service user 120, retrieved according to a revenue distribution rate rule of the service user 120, is added to a predetermined revenue.

The user interface 220 receives content information and information about the sponsored tag setting from the service user 120, when the service user 120 sets and registers the content and at least one sponsored tag associated with the content. Also, the user interface 220 receives the advertisement keyword selection list or advertising information selection list, and provides the advertisement keyword selection list or advertising information selection list to the service user 120. The advertisement keyword selection list or advertising information selection list is extracted in response to a search request for a particular keyword inputted by the service user 120 when setting the sponsored tag.

Specifically, the user interface 220 receives a request for ‘upload contents’ from the service user 120, and provides the service user 120 with a user interface screen (UI 100 of FIG. 5A and UI 200 of FIG. 5B) in which the service user 120 may set and register the content and at least one sponsored tag associated with the content in response to the request. As illustrated in FIGS. 5A and 5B, the user interface 220 receives content information such as a title, content, at least one tag, file name, and the like. Also, the user interface 220 enables the service user 120 to select any one of a sponsor group matching method and sponsor single matching method, and receives a keyword for generating the at least one sponsored tag according to the matching method.

Also, the user interface 220 receives a search request for a particular keyword which is inputted to generate the at least one sponsored tag, and transmit the received search request to the sponsored tag setting and storing unit 230.

Also, the user interface 220 receives an advertisement keyword query result or an advertising information query result which are extracted from the advertising information database 211 in response to the search request from the sponsored tag setting and storing unit 230. The user interface 220 provides the service user 120 with the advertisement keyword selection list (UI 110 of FIG. 5A) or advertising information selection list (UI 220 of FIG. 5B), and receives a selection of any one advertisement keyword or advertising information from the service user 120.

Also, the user interface 220 receives a content registration request from the service user 120 and transmits the content registration request to the sponsored tag setting and storing unit 230.

FIGS. 5A and 5B illustrate examples of user interface screen in which a service user sets and registers a content and sponsored tag associated with the content via a user interface 220 according to an exemplary embodiment of the present invention.

Referring to FIGS. 5A and 5B, when the service user 120 inputs and selects information about setting at least one sponsored tag associated with a particular content via the user interface 220, the sponsored tag setting and storing unit 230 automatically generate advertising mapping data including a sponsored tag corresponding to the information. Also, the sponsored tag setting and storing unit 230 stores the generated advertising mapping data, predetermined additional information, and content information in a user information database 212 and a content information database 213 associated with the user information database 212. In this instance, the predetermined additional information and content information are inputted by the service user 120 in association with the setting of the sponsored tag.

Specifically, when the service user 120 selects any one of a sponsor group matching method and sponsor single matching method via the user interface 220 and sets the at least one sponsored tag depending on the above matching methods, the service user 120 inputs a random keyword in a search window (UI 105 of FIG. 5A and UI 205 of FIG. 5B) and requests for a search in the sponsored tag setting and storing unit 230. The random keyword is highly related to the content in association with the setting of the at least one sponsored tag. The sponsored tag setting and storing unit 230 extracts an advertisement keyword query result and advertising information keyword query result based on a corresponding sponsored tag setting method and keyword from the advertising information database 211, and receives a selection of any one of the query results from the service user 120. That is, the sponsored tag setting and storing unit 230 automatically generates the advertising mapping data including the sponsored tag corresponding to the selected query result, and stores and/or maintains the generated advertising mapping data, the predetermined additional information, and the content information in the user information database 212 and the content information database 213 associated with the user information database 212.

When the service user 120 selects the sponsor group matching method and sets the at least one sponsored tag, the sponsored tag setting and storing unit 230 searches an advertisement keyword table of an advertising information list (FIG. 3B) for all advertisement keywords including a keyword which is inputted by the service user 120 via the search window, and extracts the advertisement keyword query result. The advertising information list, illustrated in FIG. 3B, is stored in the advertising information database 211. Also, the sponsored tag setting and storing unit 230 provides the service user 120 with an advertisement keyword selection list (UI 110 of FIG. 5A) via the user interface 220.

When the service user 120 selects an advertisement keyword which is highly related to or identical to a corresponding content from the advertisement keyword selection list (UI 110 of FIG. 5A) via the user interface 220, the sponsored tag setting and storing unit 230 receives the selection, maps the selected advertisement keyword to the sponsored tag, and exposes the advertisement keyword to the user interface 220. Also, when the service user 120 clicks the corresponding sponsored tag, the sponsored tag setting and storing unit 230 enables an advertisement result list (UI 120 of FIG. 5A) corresponding to the sponsored tag, i.e. the advertisement keyword, to be provided, and enables the advertisement keyword which is highly related to or identical to the corresponding content to be selected.

Also, when an expected service visitor, i.e. the service user 120 as the service visitor 130, clicks a sponsored tag (UI 311 of FIG. 5C) displayed with a content in a content detail view page (UI 300 of FIG. 5C), the sponsored tag setting and storing unit 230 may enable the service user 120 to previously view an advertisement result list (UI 322 of FIG. 5C) provided in response to the click, and select an advertisement keyword.

In this instance, a content of advertisement result list corresponding to a particular advertisement keyword selected by the service user 120 may vary every time the service user 120 clicks the sponsored tag, an order of the advertisement result list may be determined based on a cost per click corresponding to the advertisement keyword. The cost per click may vary according to sponsors 110, and advertising information, registered including an identical advertisement keyword, may be generated from time to time. In this instance, a difference of the content of advertisement result list depending on the point of time is irrelevant in the sponsor group matching method, since the sponsor group matching method matches the content with the advertising information using an advertisement keyword registered by the sponsor 110. That is, since the advertisement result list includes the advertisement keyword set by the service user 120, i.e. advertisement result corresponding to the sponsored tag, the difference of the content of advertisement result list depending on the point of time is irrelevant.

The sponsor match advertisement service system 200 estimates a content matching index of sponsored tag for each set sponsored tag. A method of estimating the content matching index of a particular sponsored tag is as follows. An advertisement keyword corresponding to the sponsored tag set by the service user 120 is extracted. It is determined whether at least one keyword, which is identical to the advertisement keyword, exists in content information corresponding to the set sponsored tag based on the extracted advertisement keyword as a search condition. The content information includes a title, content, tag, and the like. When the at least one keyword exists, a numerical value ‘1’ is adjusted to the content matching index. When the at least one keyword does not exist, a numerical value ‘0’ is adjusted to the content matching index. The numerical value ‘1’ indicates a content matching, and the numerical value ‘0’ indicates a content mismatching.

Hereinafter, referring to FIGS. 3C, 3E, and 5A, when a service user 120 sets a content and a sponsored tag associated with the content, an example of setting the sponsored tag according to the sponsor group matching method is described.

When the service user 120 registers the content and the sponsored tag and selects the sponsor group matching method, a user interface (UI 100 of FIG. 5A) is displayed.

The service user 120 inputs a title as ‘Nike basketball freestyle performance’, a content as ‘highlight last performance’, a tag as ‘stick figure, Nike shoes, freestyle, Ronaldo’, and a file name as “c:/documents/abc.swf” via the user interface (UI 101, UI 102, UI 103, and UI 104 of FIG. 5A) in order to provide a UCC and advertising information associated with the UCC. A file name of the UCC is “abc.swf” and the UCC is in Flash format. Also, the service user 120 selects the sponsor group matching method to provide advertising information suitable for the UCC, since the service user 120 considers information associated with ‘Nike shoes’ as advertising information which is helpful when the service user 120 as the service visitor 130 watches the UCC registered by the service user 120.

Accordingly, the service user 120 inputs ‘Nike’ as a keyword in a keyword input window (UI 105 of FIG. 5A) to extract most appropriate advertisement keyword associated with ‘Nike shoes’ from advertising information of the sponsor 110, and pushes a search button (UI 106 of FIG. 5A) to request advertising information. The requested information is transmitted to the sponsored tag setting and storing unit 230 via the user interface 220. The sponsored tag setting and storing unit 230 searches an advertisement keyword table of an advertising information list, illustrated in FIG. 3B, for all advertisement keywords including the keyword, i.e. ‘Nike’, which is inputted by the service user 120 via the search window. That is, all the advertisement keywords including the keyword, i.e. ‘Nike’ include ‘Nike’, ‘Nike shoes’, ‘Nike bag’, ‘Nike clothing’, and the like. Also, the sponsored tag setting and storing unit 230 provides an advertisement keyword selection list (UI 110 of FIG. 5A) including all the advertisement keywords including the keyword. In this instance, the service user 120 may perceive ‘Nike shoes’ as an advertisement keyword from among the advertisement keyword selection list, and selects a corresponding keyword.

The sponsored tag setting and storing unit 230 temporarily stores the ‘Nike shoes’ advertisement keyword as ‘selected sponsored tag=Nike shoes’ and displays the same via the user interface, as illustrated in UI 107 of FIG. 5A. The service user 120 clicks a displayed sponsored tag, i.e. ‘Nike shoes’, to request a response result. The sponsored tag setting and storing unit 230 receiving the request searches the advertisement keyword table of the advertising information list (FIG. 3B) for ‘Nike shoes’ advertisement keywords, and retrieves all advertising information including ‘Nike shoes’ as the advertisement keyword in order to provide an advertisement result list corresponding to the ‘Nike shoes’ advertisement keyword. Also, the sponsored tag setting and storing unit 230 determines an order of the advertisement result list based on a cost per click of corresponding advertising information, and provides an advertisement result list (UI 120 of FIG. 5A) including information about a predetermined number of advertisements, e.g. five advertisements in the UI 120 of FIG. 5A. When the service user 120 is unsatisfied with the sponsored tag set by the service user 120, the service user 120 may cancel and reset the sponsored tag.

Also, the service user 120 may set a predetermined number of other sponsored tags associated with the content. Although three sponsored tags may be set in the present embodiment of the present invention, the present invention is not limited to the embodiment. When the service user 120 sets the sponsored tag with respect to the ‘Nike shoes’ advertisement keyword, clicks a registration button (UI 108 of FIG. 5A), and requests ‘upload content’ registration, the sponsored tag setting and storing unit 230 receiving the request estimates a content matching index of the sponsored tag with respect to the set sponsored tag, i.e. ‘Nike shoes’. In this instance, the sponsored tag setting and storing unit 230 retrieves content information such as a title, content, tag, and the like, corresponding to the sponsored tag using the set sponsored tag, i.e. ‘Nike shoes’ as a search condition, and determines whether at least one keyword which is identical to the search condition exists. In the present embodiment, the ‘Nike shoes’ keyword exists in a tag of the content. Accordingly, the sponsored tag setting and storing unit 230 generates a content matching index of the sponsored tag as ‘1’. Then, referring to FIGS. 3C, 3D, and 3E, the sponsored tag setting and storing unit 230 stores and maintains the content information, inputted by the service user 120, a sponsored tag setting identifier, i.e. sponsor group matching method, all information associated with remaining set sponsored tags in the user information database 212 and content information database 213 associated with the user information database 212.

Hereinafter, an example in which the service user 120 selects the sponsor single matching method and sets a single sponsored tag is described. The sponsored tag setting and storing unit 230 searches a sponsor name table of a sponsor information list and an advertisement keyword table, title table, content table of an advertising information list for all advertising information including a corresponding keyword. The sponsor information list is illustrated in FIG. 3A and stored in the advertising information database 211, and the advertising information list is illustrated in FIG. 3B. Also, the sponsored tag setting and storing unit 230 extracts an advertising information keyword query result, and provides the service user 120 with an advertising information selection list (UI 220 of FIG. 5B) via the user interface 220. Then, when the service user 120 selects particular sponsor's advertising information which is highly related to or identical to a corresponding content from the advertising information selection list (UI 220 of FIG. 5B) via the user interface 220, the sponsored tag setting and storing unit 230 receives the selection, maps the title of the selected advertising information to the sponsored tag, and stores an advertising information identifier of the advertising information in interoperation with the sponsored tag. Also, the sponsored tag setting and storing unit 230 displays the sponsored tag and a site path of the advertising information, i.e. URL information of a site, on the user interface 220. Here, the advertising information identifier is required to map the sponsored tag to the title of a particular advertisement. Specifically, when an expected service user 120 or service visitor 130 clicks the sponsored tag, advertising information corresponding to the sponsored tag may not be extracted using the title.

Also, the sponsored tag setting and storing unit 230 receives detailed path information (UI 209 of FIG. 5B) of advertising information site, i.e. a sub-URL which enables the service user 120 to access a particular sub page of the advertising information site, from the service user 120 via the user interface 220. Also, the sponsored tag setting and storing unit 230 determines whether the site path is correct in response to a request of the service user 120.

FIG. 5B is a diagram illustrating an example of user interface in which a sponsored tag is set according to a sponsor single matching method when setting a content and a sponsored tag associated with the content.

Hereinafter, referring to FIGS. 3C, 3E, and 5B, when a service user 120 sets a content and a sponsored tag associated with the content, an example of setting a sponsored tag according to the sponsor single matching method is described.

When the service user 120 registers the content and the sponsored tag and selects the sponsor single matching method, a user interface (UI 200 of FIG. 5B) is displayed.

As an example, the service user 120 inputs a title as ‘beautiful girl of Ewha women's university on the street’, a content as ‘look of Ewha women's university student interviewed on the street’, a tag as ‘summer, sunglasses, interview, ewha women's university, fashion’, and a file name as ‘c:/documents/sunglass.swf’ via the user interface (UI 201, UI 202, UI 203, and UI 204 of FIG. 5A) in order to provide a UCC and advertising information associated with the UCC. A file name of the UCC is “sunglass.swf” and the UCC is in Flash format. Also, the service user 120 selects the sponsor single matching method to provide advertising information suitable for the UCC.

In this instance, the service user 120 desires to provide a service visitor 130 with detailed information about sunglass in the UCC, for example, information about a website selling sunglasses. Also, according to the present embodiment of the present invention, a sponsor 110 is ‘TOTAL SUNGLASS’, an advertisement website of advertising information of the sponsor 110 is ‘http://www.totalsun.co.kr’, and the sponsor 110 desires to directly access to a sub-page of a website having information about ‘Christian Dior sunglass’ product included in the content.

Accordingly, the service user 120 inputs ‘Christian Dior sunglass’ as a keyword in a keyword input window (UI 205 of FIG. 5B) to extract most appropriate advertisement keyword associated with ‘Christian Dior sunglass’ from advertising information of the sponsor 110, and pushes a search button (UI 206 of FIG. 5B) to request advertising information. When the service user 120 already knows a sponsor name, the sponsor name, i.e. ‘TOTAL SUNGLASS’, may be inputted to retrieve advertising information more rapidly. The requested information is transmitted to a sponsored tag setting and storing unit 230 via the user interface 220. The sponsored tag setting and storing unit 230 searches a sponsor name table of a sponsor list, and a title, content, keyword table of an advertising information list illustrated in FIG. 3B. In this instance, the sponsor list is illustrated in FIG. 3A and stored in an advertising information database 211. Also, the sponsored tag setting and storing unit 230 retrieves all advertising information including ‘Christian Dior’ keyword, and provides an advertising information selection list (UI 220 of FIG. 5B). In this instance, the service user 120 may perceive ‘http://www.totalsun.co.kr’ as an advertisement website from among the advertising information selection list, and selects corresponding advertising information.

The sponsored tag setting and storing unit 230 temporarily stores the advertising information as ‘selected sponsored tag=luxury sunglasses, advertising information identifier=AD2007050002’ and displays the same via the user interface, as illustrated in UI 207 of FIG. 5B. In this instance, the title of the advertising information is ‘luxury sunglasses’ and the website is ‘http://www.totalsun.co.kr’. The service user 120 clicks a displayed sponsored tag, i.e. ‘luxury sunglasses’, to request a response result. The sponsored tag setting and storing unit 230 receiving the request retrieves the advertising information having the advertising information of ‘AD2007050002’ from an advertising information identifier table of the advertising information list illustrated in FIG. 3B in order to provide an advertisement result list corresponding to ‘advertising information identifier=AD2007050002’ and ‘sponsored tag=luxury sunglasses’.

Also, when the service user 120 is unsatisfied with the sponsored tag set by the service user 120, the service user 120 may cancel and reset the sponsored tag. The service user 120 may input a detailed URL of a sub-page of an advertisement website including ‘Christian Dior’ product. For this, the service user 120 is required to access to a main page of the advertisement website ‘http://www.totalsun.co.kr’, and move to the sub-page including a particular ‘Christian Dior’ sunglass. Also, the service user 120 is required to copy a sub-page URL displayed on an Internet browser to input ‘shop/goods/goods_view.php?goodsno=9994503’ in a detailed path input window (UI 209 of FIG. 5B), or directly input the sub-page URL. When the service user 120 finishes the input and requests confirmation, the sponsored tag setting and storing unit 230 confirms whether the site path is correct in response to the request of the service user 120.

Also, the service user 120 may set a predetermined number of other sponsored tags associated with the content. Although three sponsored tags may be set in the present embodiment of the present invention, the present invention is not limited to the embodiment. When the service user 120 sets the sponsored tag as ‘luxury sunglass’, clicks a registration button (UI 210 of FIG. 5B), and requests ‘upload content’ registration, the sponsored tag setting and storing unit 230 receiving the request estimates a content matching index of the sponsored tag with respect to the set sponsored tag, i.e. ‘luxury sunglass’. When an advertisement keyword corresponding to the set sponsored tag is extracted, ‘Christian Dior’ and ‘Sunglasses’ may be obtained. In this instance, the sponsored tag setting and storing unit 230 retrieves content information such as a title, content, tag, and the like, corresponding to the sponsored tag using the set sponsored tag, i.e. ‘Christian Dior’ and ‘Sunglasses’ as a search condition, and determines whether at least one keyword which is identical to the search condition exists. According to the present embodiment, the ‘Sunglasses’ keyword exists in a tag and title of the content.

Accordingly, the sponsored tag setting and storing unit 230 generates the content matching index of the sponsored tag as ‘1’. Then, referring to FIGS. 3C, 3D, and 3E, the sponsored tag setting and storing unit 230 stores and maintains the content information, inputted by the service user 120, a sponsored tag setting identifier, i.e. sponsor group matching method or sponsor single matching method, all information associated with remaining set sponsored tags in the user information database 212 and content information database 213 associated with the user information database 212.

Also, when the service user 120 sets detailed information of the content and the sponsored tag as described above and requests a registration of the content via the user interface 220, the sponsored tag setting and storing unit 230 receives the request and estimate a content matching index of the sponsored tag with respect to at least one set sponsored tag, respectively.

In this instance, the content matching index of the sponsored tag is data required to estimate a reliability index of the sponsored tag. The content matching index of the sponsored tag is generated by searching content detailed information corresponding to the sponsored tag using the set sponsored tag as the search condition and determining whether at least one keyword which is identical to the keyword exists. The content detailed information includes the title, content, tag, and the like. Also, the sponsored tag setting and storing unit 230 stores the content information inputted by the service user 120, the sponsored tag which is set by matching the content, and additional information in the user information database 212 and content information database 213. The content information includes the title, content, tag, file name, and the like. The additional information is generated, retrieved, and received while setting the sponsored tag, and includes a sponsored tag identifier, advertising information identifier, detailed path of advertisement website, content matching index of the sponsored tag, and the like.

A visitor interface 240 receives a service request from the service visitor 130, and provides the service visitor 130 with a detailed information view screen including the sponsored tag, advertisement result list, and advertisement website in response to the request. Also, the visitor interface 240 receives and stores a content view request, sponsored tag click request, and recommendation or objection input with respect to the advertisement result list of the service visitor 130.

Specifically, the visitor interface 240 receives a particular content view request from the service visitor 130 and transmits the request to a sponsored tag display unit 250. The visitor interface 240 is provided with a result value, i.e. a detailed information view screen of corresponding content (UI 300 of FIG. 5C or UI 400 of FIG. 5D), and displays the result value on a terminal 135 connected to the service visitor 130.

Also, the user interface 240 receives the sponsored tag click request displayed on the detailed information view screen from the service visitor 130, and transmits the request to an advertising list extraction unit 260. The user interface 240 is provided with a result value, i.e. an advertisement result list with respect to the sponsored tag (UI 320 of FIG. 5C or UI 420 of FIG. 5D), and displays the result value on the terminal 135 connected to the service visitor 130. Also, when the service visitor 130 selects advertising information from the advertisement result list, the visitor interface 240 transmits the advertising information to the advertising list extraction unit 260, and provides the service visitor 130 with a result value, i.e. an advertisement website mapped to the advertising information (UI 430 of FIG. 5D).

Also, the visitor interface 240 receives and stores the content view request, sponsored tag click request, and recommendation or objection input with respect to the advertisement result list of the service visitor 130, and stores the received request and input in a content list, illustrated in FIG. 3D, of the content information database 213.

FIGS. 5C and 5D are diagrams illustrating screens provided to a service visitor 130 by a visitor interface 240 when the service visitor 130 inputs a content view request, sponsored tag click request, and particular advertisement selection request from an advertisement result list via a user interface 240 according to an embodiment of the present invention.

A sponsored tag display unit 250 receives the content view request of the service visitor 130 from the visitor interface 240, and provides the service visitor 130 with content information and a sponsored tag associated with the content information via the visitor interface 240. The content information and the sponsored tag correspond to the content view request. Also, the sponsored tag display unit 250 retrieves content information and sponsored tag-related information from a content information database 213. In this instance, the content information and sponsored tag-related information correspond to a content identifier included in the content view request received from the visitor interface 240. The sponsored tag display unit 250 estimates a reliability index of the sponsored tag using information which is required to estimate the reliability index of the sponsored tag from among the content information and sponsored tag-related information. The sponsored tag display unit 250 provides a ranking to the estimated reliability index according to a predetermined ranking standard, and provides the service visitor 130 with the content information and the sponsored tag-related information via the visitor interface 240.

Hereinafter, referring to FIG. 4D, the estimating of the reliability index of the sponsored tag is described.

According to the present embodiment of the present invention, the reliability index of the sponsored tag is estimated by the sponsored tag display unit 250 by referring to the content information database 213. An advertising effect index of the sponsored tag is estimated using a page view of content and a number of clicks on the sponsored tag of the service visitor 130 with respect to a content and the sponsored tag. Specifically, the advertising effect index of the sponsored tag is estimated using the number of clicks on the sponsored tag with respect to the page view of content. The page view of content is the same as a number of exposures of sponsored tag. A visitor evaluation index of the sponsored tag is estimated using a number of clicks for recommendation and a number of clicks for objection of the service visitor 130 with respect to an advertisement result list which is extracted by the sponsored tag. Specifically, the visitor evaluation index of the sponsored tag is estimated using the number of clicks for recommendation with respect to a value obtained by summing the number of clicks for recommendation and the number of clicks for objection. Also, the reliability index of the sponsored tag, i.e. a sponsor match reliability index of the sponsored tag, is estimated by reading content matching index data of the sponsored tag, and using the advertising effect index, the visitor evaluation index, the content matching index, and a weight with respect to each of the advertising effect index, the visitor evaluation index, and the content matching index. The content matching index data of the sponsored tag is estimated and stored by the sponsored tag setting and storing unit 230. The weight with respect to each of the advertising effect index, the visitor evaluation index, and the content matching index is provided according to a predetermined weight standard. The weight provided for each index may be controlled by a service system manager according to the present invention.

An example of the estimating the reliability index of the sponsored tag is described below. When the service visitor 130 requests a content information view of a content ‘Nike soccer freestyle performance’, illustrated in FIG. 5C, via the visitor interface 240, the sponsored tag display unit 250 estimates the sponsor match reliability index of ‘Nike shoes’ (UI 311 of FIG. 5C) prior to providing the service visitor 130 with a content detail view screen (UI 300 of FIG. 5C). The ‘Nike shoes’ is the sponsored tag corresponding to the content ‘Nike soccer freestyle performance’.

The sponsored tag display unit 250 estimates an advertising effect index of the sponsored tag by referring to a page view of the content, for example, 5012 times, and a number of clicks on the sponsored tag, for example, 2356 times. That is, the advertising effect index of the sponsored tag is 0.47 according to the above-described estimation operation, i.e. ‘2356/5012’. In this instance, a content identifier of the content is ‘200705020001’ from information about a list, illustrated in FIG. 3D, of the content information database 213. A sponsored tag identifier of the sponsored tag is ‘ST20070502001’ from information about a sponsored tag list, illustrated in FIG. 3E, of the content information database 213. Also, the information about the sponsored tag list illustrated in FIG. 3E is sponsored tag information corresponding to the content.

Also, the sponsored tag display unit 250 estimates a visitor evaluation index by referring to a number of clicks for recommendation, for example, 150 times, and a number of clicks for objection, for example, 50 times. That is, the visitor evaluation index of the sponsored tag is 0.75 according to the above-described estimation operation, i.e. ‘150/(150+50)’. In this instance, a sponsored tag identifier of the sponsored tag is ‘ST200705020001’ from information about a content list, illustrated in FIG. 3E, of the content information database 213.

Also, the sponsored tag display unit 250 refers to a content matching index data value, for example, 1, of the sponsored tag. In this instance, the sponsored tag identifier of the sponsored tag is ‘ST200705020001’ from information about the content list, illustrated in FIGS. 3D and 3E, of the content information database 213.

The sponsored tag display unit 250 calculates the advertising effect index, visitor evaluation index, and the content matching index as described above, and provides the weight for each of the advertising effect index, visitor evaluation index, and the content matching index. Accordingly, the sponsor match reliability index of the sponsored tag, i.e. ‘Nike shoes’ is calculated.

According to the present embodiment of the present invention, when it is assumed that the weight with respect to the advertising effect index is 40%, the weight with respect to the visitor evaluation index is 40%, and the weight with respect to the content matching index is 20%, and thus the sponsor match reliability index is ((2356/5012)*40)+((150/(150+50))*40)+(1*20)=68.8%.

An example of providing the ranking with respect to the estimated reliability index of the sponsored tag and displaying the ranked sponsored tag is described.

According to the present embodiment of the present invention, the ranking standard with respect to the sponsor match reliability index is ‘different’ when the reliability index is 0% to 30%, ‘average’ when the reliability index is 30% to 70%, and ‘identical’ when the reliability index is 70% to 100%. Also, when displaying the sponsored tag via the user interface 220 according to the ranking standard, a character color of the sponsored tag is displayed differently. Specifically, when the reliability index corresponds to ‘different’, a character color of the sponsored tag is red, when the reliability index corresponds to ‘average’, a character color of the sponsored tag is black, and when the reliability index corresponds to ‘identical’, a character color of the sponsored tag is blue.

Accordingly, since the reliability index of the sponsored tag, i.e. ‘Nike shoes’ is 68.8%, the reliability index of ‘Nike shoes’ corresponds to ‘average’, and thus a sponsor match advertisement service system 200 displays a character color of ‘Nike shoes’ in black to the service visitor 130. The above-described ranking standard and the method of displaying the ranked sponsored tag are an example of the present invention, and may be provided in a more convenient way.

Also, according to the present invention, the sponsor match reliability index of the sponsored tag, which is set by the service user 120 in association with a particular content, is calculated, and the ranking standard and the method of displaying the sponsored tag are differentiated from others. In this instance, the sponsor match reliability index of the sponsored tag corresponds to a reliability index indicating a level of association between the content and advertising information. Accordingly, a sponsor match advertisement service which improves a reliability of advertising information for the service visitor 130 and a sponsor 110, and may match a reliable advertisement more actively for the service user 120 may be embodied. The service user 120 acquires an advertising revenue in proportion to a number of advertisement access clicks by the service visitor 130.

Also, according to the present invention, an indirect exposure method which exposes advertising information such as a title, content, and URL of a corresponding sponsor when the service visitor 130 clicks a single sponsored tag after displaying a plurality of set sponsored tags in a text form like a content, is provided. Accordingly, an aversion to an advertising exposure may be reduced in comparison to a direct exposure method. Also, advertising information is provided by selecting a sponsored tag appealing to the service visitor 130 from the plurality of set sponsored tags. Accordingly, a purchase intention and interest of the service visitor 130 are taken into account, and thus a purchase conversion rate may be improved.

When the service visitor 130 makes a sponsored tag click request via the visitor interface 240, the advertising list extraction unit 260 receives the request, extracts an advertisement result list corresponding to a sponsored tag, and provides the service visitor 130 with the advertisement result list via the visitor interface 240. Also, when the service visitor 130 selects particular advertising information from the provided advertisement result list, the advertising list extraction unit 260 provides an advertisement website of a sponsor corresponding to the particular advertising information via the visitor interface 240.

Also, the advertising list extraction unit 260 requests a calculation unit 270 for an advertising information calculation to estimate a predetermined advertising cost with respect to the sponsor 110 and the service user 120 according to an advertising information click.

Specifically, when the advertising list extraction unit 260 receives the sponsored tag click request associated with a particular content from the visitor interface 240, sponsored tag setting identifier information corresponding to the content is extracted, and different advertisement result lists are extracted according to a type of the identifier.

When a sponsored tag setting identifier is a sponsor group matching method, the advertising list extraction unit 260 retrieves all advertising information corresponding to the sponsored tag from an advertising information database 211, and realigns the extracted advertising information list in an order of highest cost per an advertisement keyword click. Also, the advertising list extraction unit 260 transmits the advertisement result list to the visitor interface 240. The advertisement result list is generated by assigning a predetermine number of advertisements from the realigned advertising information list in an order of highest priority.

When the sponsored tag setting identifier is a sponsor single matching method, the advertising list extraction unit 260 retrieves an advertising information identifier corresponding to the sponsored tag from an advertising information database 211, and transmits an advertising information of the advertising information identifier to the visitor interface 240.

Also, when the service visitor 130 clicks particular advertising information from among the advertisement result list which is provided via the visitor interface 240, the advertising list extraction unit 260 opens a new Internet browser window and connects to an advertisement website of a sponsor corresponding to the particular advertising information. The particular advertising information corresponds to advertising information about at least one advertisement. In this instance, the advertising list extraction unit 260 transmits a calculation request with respect to the advertising information to the calculation unit 270, and enables an advertising revenue distribution calculation with respect to the service user 120 and an advertising cost calculation with respect to the sponsor 110 to be made.

Hereinafter, referring to FIGS. 5C and 5D, when the service visitor 130 clicks a single sponsored tag in a content detail view screen (UI 300 of FIG. 5C or UI 400 of FIG. 5D) provided in response to a content view request from the service visitor 130, an example of extracting the advertisement result list differently according to a type of the sponsored tag setting identifier is described.

According to the present embodiment of the present invention, the content view request indicates that the service user 120 clicks brief information of content to view detailed information about a single content on a service page which displays the brief information of the content provided when using a service according to the present invention.

In FIG. 5C, when the service visitor 130 looks at a content detail view page (UI 300 of FIG. 5C) of a content having a title of ‘Nike soccer freestyle performance’, and clicks the sponsored tag, i.e. ‘Nike shoes’ (UI 311 of FIG. 5A), the advertising list extraction unit 260 receiving the sponsored tag click request reads sponsored tag setting identifier information corresponding to the content ‘Nike soccer freestyle performance’ from the content information database 213. A character color of the sponsored tag, i.e. ‘Nike shoes’ (UI 311 of FIG. 5A) is black.

In this instance, since the sponsored tag setting identifier is the sponsor group match method, the advertising list extraction unit 260 extracts the advertisement result list according to the sponsor group match method. Accordingly, the advertising list extraction unit 260 searches an advertisement keyword table of an advertising information list for an advertisement keyword ‘Nike shoes’, and retrieves all advertising information having ‘Nike shoes’ as the advertisement keyword in order to provide an advertisement result list corresponding to the advertisement keyword ‘Nike shoes’ using the advertisement keyword ‘Nike shoes’ as a search keyword. The advertising information list, illustrated in FIG. 3B, is stored in the advertising information database 211.

The advertising list extraction unit 260 realigns the advertisement list in an order of highest cost per an advertisement click with respect to corresponding advertising information, and provides the service visitor 130 with the advertisement result list (UI 320 of FIG. 5C). In this instance, the advertisement result list is generated by retrieving advertising information about a predetermine number of advertisements, for example, advertising information about five advertisements, from the realigned advertising list in an order of highest priority.

In FIG. 5D, when the service visitor 130 views at a content detail view page (UI 400 of FIG. 5D) of a content having a title of ‘a beautiful girl of Ewha women's university on a street’, and clicks the sponsored tag, i.e. ‘luxury sunglasses’ (UI 411 of FIG. 5D), the advertising list extraction unit 260 receiving the sponsored tag click request reads sponsored tag setting identifier information corresponding to the content ‘a beautiful girl of Ewha women's university on a street’ from the content information database 213.

In this instance, since the sponsored tag setting identifier is the sponsor single match method, the advertising list extraction unit 260 extracts the advertisement result list according to the sponsor single match method. Accordingly, the advertising list extraction unit 260 extracts an advertising information having an advertising information identifier of ‘AD2007050002’ from an advertising information identifier table of an advertising information list, and provides the advertising information as an advertisement result list (UI 420 of FIG. 5D) in order to provide the advertisement result list corresponding to the sponsored tag ‘luxury sunglasses’ and the advertising information identifier of ‘AD2007050002’. The advertising information list, illustrated in FIG. 3B, is stored in the advertising information database 211.

In FIGS. 5C and 5D, when looking at the advertising information on the advertisement result list, the service visitor 130 may selectively suggest an opinion for using a recommendation or objection button according to whether the service visitor 130 may be satisfied with desired advertising information, i.e. whether the advertising information on the advertisement result list is highly related to a corresponding content. In this instance, a sponsor match advertisement service system 200 may trace an Internet protocol (IP) address of the service visitor 130 and enable a same IP address to be counted only once regardless of a number of accesses in order to prevent a incorrect click count caused by the service visitor 130.

The calculation unit 270 performs an advertising revenue distribution calculation with respect to the service user 120 and an advertising cost calculation with respect to the sponsor 110 according to a particular advertisement click of the service visitor 130. The advertising revenue distribution calculation with respect to the service user 120 is associated with the clicked advertisement.

That is, the calculation unit 270 receives a calculation request associated with an advertisement click of the service visitor 130 from the advertising list extraction unit 260. Also, the calculation unit 270 performs an inquiry with respect to a calculation information list of the calculation information database 214 and generation of the calculation information list, and maintains and stores required information for a calculation of the sponsor 110 and the service user 120.

Also, the calculation unit 270 extracts advertising cost per click of the clicked advertising information. The calculation unit 270 deducts the extracted advertising cost per click from account information of the sponsor 110 corresponding to the advertising information, and sums calculation information of a corresponding service user 120 and a predetermined revenue according to a revenue distribution rate rule.

Specifically, when receiving the calculation request associated with particular advertising information from the advertising list extraction unit 260, the calculation unit 270 stores a number of accumulated advertisement clicks with respect to the advertisement click. For this, the calculation unit 270 sequentially checks a calculation information list, illustrated in FIG. 3F, of the calculation information database 214, and combines advertising information and content which cause the extraction of the advertising information, i.e. the calculation information list with respect to the advertising information. Accordingly, the calculation unit 270 checks whether the calculation information list having the advertising information and the content as keys exists. When the calculation information list exists, a number of advertisement clicks ‘1’ is accumulated and stored in an item of a number of advertisement clicks of the calculation information list. When the calculation information list does not exist, a new calculation information list is generated. The new calculation information list includes an advertising information identifier, a content identifier associated with the advertising information, and the number of advertisement clicks. Accordingly, the calculation unit 270 stores information about the advertising information identifier, the content identifier, and the number of advertisement clicks as ‘1’.

When the calculation unit 270 uses a value of the advertising information identifier and a value of the content information of the calculation information list as a condition, an advertising cost per click corresponding to the advertising information identifier, and information about a corresponding sponsor and the service user may be retrieved from the advertising information database 211, user information database 212, and content information database 213. The calculation information list is stored in the calculation information database 214. The calculation unit 270 deducts the extracted advertising cost per click from the account information of the sponsor 110 corresponding to the advertising information, and sums the calculation information of the service user 120 and the predetermined revenue according to the revenue distribution rate rule. Accordingly, the advertising cost with respect to the sponsor 110 and the revenue distribution calculation with respect to the service user 120 may be performed.

Hereinafter, referring to FIGS. 3A, 3C, and 3F, a method of deducting a predetermined advertising cost from the account information of the sponsor 110 and a method of summing the calculation information of the service user 120 and the predetermined revenue are described.

As an example, according to an embodiment of the present invention, it is assumed that a service user revenue distribution rate with respect to the advertising cost per click is 30%, a numerical value of initial advertisement account information, i.e. an initial advertisement deposit of a sponsor 110 which is ‘real shopping’, is 500,000 WON, and a numerical value of initial account information of a sponsor 110 which is ‘TOTAL SUNGLASS’ is 1,000,000 WON. Also, it is assumed that two calculation information lists are included in the calculation information database 214. In this instance, a calculation information list includes an advertising information identifier of ‘AD2007050001’, a content identifier of ‘20070520001’, and a number of advertisement clicks of ‘156’. Another calculation information list includes an advertising information identifier of ‘AD2007050002’, a content identifier of ‘200705060002’, and a number of advertisement clicks of ‘340’.

Referring to FIGS. 3A and 3C, the above-described calculation information list includes information about a sponsor, advertising information identifier, and content identifier, and the like, for each content which is registered by the service user 120. In this instance, a user ID of the service user 120 is ‘honggildong’, and the content registered by the service user 120 indicates two contents. First, since the service user 120 sets a sponsored tag as ‘Nike shoes’, a content identifier is ‘20070520001’, a sponsor is ‘real shopping’, an advertising information identifier is ‘AD2007050001’, and a number of advertisement click corresponds to 156 times. Second, since the service user 120 sets a sponsored tag ‘luxury sunglasses’, a content identifier is ‘200705060002’, a sponsor is ‘TOTAL SUNGLASS’, an advertising information identifier is ‘AD2007050002’, and a number of advertisement click corresponds to 340 times. An advertising cost per click with respect to each advertising information is ‘100 WON’ and ‘110 WON’, respectively. Accordingly, numerical values of account information of the two sponsors are ‘500,000 WON−(156 times*100 WON)=484,400 WON’ and ‘1,000,000 WON−(340 times*110 WON)=962,600 WON’, that is, 484,400 WON and 962,600 WON, respectively. Also, a numerical value of calculation information about an advertising revenue of the service user 120 is ‘(156 times*100 WON*30%)=(340 times*110 WON*30%)=16,040 WON’, that is, 16,040 WON.

In this instance, when the service visitor 130 clicks the sponsored tag ‘Nike shoes’ on the content detail view page (UI 300 of FIG. 5C), and clicks a first advertisement of the advertisement result list (UI 320 of FIG. 5C), the advertising list extraction unit 260 receiving the click selection displays a corresponding advertisement website to the service visitor 130 and requests the calculation unit 270 for a calculation according to the advertisement click. In this instance, the first advertisement has a URL of ‘http://www.realpicky.com’.

The calculation unit 270 receiving the request retrieves the advertising information identifier (=‘AD2007050001’) and content identifier (=‘20070520001’) from the clicked advertising information in order to store a number of clicks with respect to the advertisement click. Also, the calculation unit 270 sequentially searches the calculation information database 214 using the two identifiers as a key condition. Accordingly, the calculation unit 270 determines that the calculation information list including the advertising information identifier ‘AD2007050001’, content identifier ‘20070520001’, and the number of advertisement clicks ‘156 times’ exists. Thus, the calculation unit 270 retrieves information about the sponsor, user, and advertising cost per click corresponding to the advertising information using the advertising information identifier ‘AD2007050001’ and content identifier ‘20070520001’ by referring to the advertising information database 211, user information database 212, and content information database 213. Specifically, the sponsor is ‘real shopping’, the user of the content is ‘honggildong’, and the advertising cost per click is ‘100 WON’.

Then, the calculation unit 270 deducts the advertising cost per click ‘100 WON’from the extracted account information of the sponsor ‘484,400 WON’, and stores the deducted value ‘(484,400 WON−100 WON=484,300 WON)’. According to the present embodiment of the present invention, it is assumed that a user revenue distribution rate with respect to the advertising cost per click is 30%, and the calculation unit 270 sums the account information of the service user 120 and a revenue according to the advertisement click. Accordingly, a summed value is (16,040 WON+(100 WON*30%)=16,070 WON), that is, ‘16,070 WON’, which is stored in the calculation information of the service user 120.

Hereinafter, a method of providing a sponsor match advertisement service of a sponsor match advertisement service system is described.

FIG. 4A is a flowchart illustrating a method of providing a sponsor match advertisement service of a sponsor match advertisement service system according to an embodiment of the present invention.

The method of providing a sponsor match advertisement service according to the present embodiment of the present invention is performed by the sponsor match advertisement service system 200.

In operation S110, the sponsor match advertisement service system 200 maintains a user information database 212, at least one content information database 213 associated with the user information database 212, an advertising information database 210, and a calculation information database 214. The user information database 212 includes information about at least one user, and the advertising information database 210 includes information about at least one advertisement.

In operation S110, user information inputted by a service user 120, predetermined information related to a UCC registered by the service user 120, advertising/promotion information of a sponsor 110, and predetermined information required for an advertising revenue calculation of the service user 120 and advertising cost of the sponsor 110 are maintained and stored. The service user 120 is a member of the sponsor match advertisement service system 200.

In this instance, the user information includes a user ID, a password, a user name, account information, and advertising revenue calculation information, a total number of contents registered by the service user 120, a content identifier which may identify registered content information, and the like.

The content information includes content information registered by the service user 120, sponsored tag setting identifier according to a sponsored tag setting method, at least one sponsored tag, advertising information identifier which is associated with a particular sponsored tag, content match index of the sponsored tag, detailed path of advertisement website inputted by the service user 120, page views of a content, a number of clicks on the sponsored tag, a number of clicks for recommendation or objection with respect to an advertisement result list which is exposed when requesting a sponsored tag click, and the like. In this instance, the page views of a content, the number of clicks on the sponsored tag, and the number of clicks for recommendation or objection are required to estimate a reliability index of the sponsored tag.

Advertising information of the sponsor 110 includes sponsor information and information about at least one individual advertisement. The sponsor information includes a sponsor ID, a password, a sponsor name, contact information, and account information for paying an advertising cost. The information about the at least one individual advertisement includes a title, a content, a route, that is, a URL, advertisement keyword, and a cost per click. The at least one advertisement keyword is inputted to enable a service user and the sponsor match advertisement service system 200 to easily retrieve and use related information.

Calculation information includes a calculation information list. The calculation information list includes the advertising information identifier and the content identifier, which correspond to the clicked advertisement, as a key item, and a number of advertisement clicks in order to store a number of accumulated advertisement clicks. The advertising information identifier and the content identifier are required to calculate an advertising revenue distribution with respect to the service user 120 associated with the clicked advertisement and advertising cost of the sponsor 110 according to a particular advertisement click of a service visitor 130.

In operation S120, when the service user 120 inputs or selects content information and information about setting at least one sponsored tag associated with the content information via a user interface 220, the sponsor match advertisement service system 200 automatically generates advertising mapping data including the sponsored tag. Also, the sponsor match advertisement service system 200 stores the generated advertising mapping data, predetermined additional information, and the content information in the user information database 212 and the content information database 213 associated with the user information database 212. The predetermined additional information and content information is inputted by the service user 120 in association with the sponsored tag setting.

In operation S120, the sponsored tag is generated according to the sponsored tag setting method selected by the service user 120, i.e. a sponsor group matching method and sponsor single matching method.

When the service user 120 selects an advertisement keyword which is highly related to or identical to a corresponding content from an advertisement keyword table of an advertising information list, the sponsor group matching method maps the selected advertisement keyword to the sponsored tag. When the service visitor 130 clicks a corresponding sponsored tag, the sponsor group matching method provides the sponsored tag, that is, an advertisement result list corresponding to the advertisement keyword. The advertising information list is stored in the advertising information database 211.

When the service user 120 selects advertising information of a particular sponsor which is highly related to or identical to a corresponding content from advertising information stored in the advertising information database 211, the sponsor single matching method maps a title of the selected advertising information to the sponsored tag.

Hereinafter, referring to FIG. 4B, an operation of generating a user content and at least one sponsored tag associated with the content is described.

FIG. 4B is a flowchart illustrating an operation of setting and registering a sponsored tag according to an embodiment of the present invention.

In operation S200, a sponsor match advertisement service system 200 receives content information and a sponsored tag setting method to be registered via a user interface 220 from the service user 120.

In operation S200, the sponsor match advertisement service system 200 receives the content information and any one of the sponsor group matching method and sponsor single matching method. The content information includes a title, content, at least one tag, and file name of the content.

In operation S201, the sponsor match advertisement service system 200 determines whether the selected sponsored tag setting method is the sponsor group matching method or sponsor single matching method. A sponsored tag setting is differentiated based on the sponsored tag setting method.

As a result of the determining in operation S201, when the sponsored tag setting method is the sponsor group matching method, the sponsor match advertisement service system 200 receives a keyword for an advertisement keyword search from the service user 120 in operation S202. In operation S202, the service user 120 inputs a random keyword and requests a search to retrieve an advertisement keyword, which is highly related to or identical to a corresponding content, in an advertising information database 211.

In operation S203, the sponsor match advertisement service system 200 provides the service user 120 with an advertisement keyword selection list corresponding to the request. In operation S203, the sponsor match advertisement service system 200 searches an advertisement keyword table of an advertising information list, and extracts all advertisement keywords including the advertisement keyword, based on the received keyword. The advertising information list is stored in the advertising information database 211. Also, the sponsor match advertisement service system 200 provides the service user 120 with an advertisement keyword selection list (UI 110 of FIG. 5A) corresponding to an advertisement keyword query result value via the user interface 220.

In operation S204, the sponsor match advertisement service system 200 receives a selection of a single keyword associated with the content from among the advertisement keyword selection list from the service user 120. In operation S204, when an advertisement keyword desired by the service user 120 is not included in the advertisement keyword selection list or a content corresponding to the advertisement keyword selection list does not exist, the sponsor match advertisement service system 200 may receive a cancel request of the advertisement keyword from the service user 120 and may return to operation S202 or complete operation S204.

In operation S205, the sponsor match advertisement service system 200 maps the selected advertisement keyword to the sponsored tag to generate a new sponsored tag. In operation S205, the sponsor match advertisement service system 200 enables the service user 120 to determine that the new sponsored tag is generated by exposing the new sponsored tag via the user interface 220. Accordingly, when clicking the new sponsored tag on the user interface 220, the service user 120 may previously confirm an advertisement result corresponding to the sponsored tag which is set by the service user 120. Also, in operation S205, when the service user 120 is unsatisfied with the set sponsored tag, the sponsor match advertisement service system 200 receives a cancel request of the sponsored tag setting from the service user 120 and may cancel and reset the sponsored tag.

In operation S206, the sponsor match advertisement service system 200 determines whether an additional setting request of sponsored tag or content registration request is received from the service user 120.

As a result of the determining in operation S206, when the additional setting request of sponsored tag is received from the service user 120, that is, when the service user 120 requests the additional setting by using an input device of a user terminal 125 to locate an input command cursor on a search input window and setting at least one sponsored tag, the sponsor match advertisement service system 200 receives the request and returns to operation S202. The search input window may set an additional sponsored tag.

As a result of the determining in operation S206, when the content registration request is received from the service user 120, the sponsor match advertisement service system 200 estimates a content matching index of a registered sponsored tag according to the request from the service user 120 in operation S207. In operation S207, the content matching index of the sponsored tag is estimated as follows. An advertisement keyword corresponding to the sponsored tag set by the service user 120 is extracted. It is determined whether at least one keyword, which is identical to the advertisement keyword, exists in content information corresponding to the set sponsored tag based on the extracted advertisement keyword as a search condition. The content information includes a title, content, tag, and the like. When the at least one keyword exists, a numerical value ‘1’ is adjusted to the content matching index. When the at least one keyword does not exist, a numerical value ‘0’ is adjusted to the content matching index. The numerical value ‘1’ indicates a content matching, and the numerical value ‘0’ indicates a content mismatching.

In operation S208, the sponsor match advertisement service system 200 stores information about the sponsored tag setting and the content information received from the service user 120. The information about the sponsored tag setting is generated or extracted while setting the content and the at least one sponsored tag associated with the content. In operation S208, the sponsor match advertisement service system 200 stores information which is generated and retrieved for each sponsored tag setting, additional information received from the service user 120, and content information received from the service user 120 in a user information database 212 and a content information database 213. The information generated and retrieved for each sponsored tag setting includes the sponsored tag, sponsored tag setting identifier, advertising information identifier, and content matching index. The additional information includes a detailed URL, and the content information includes a title, content, tag, file name, and the like.

As a result of the determining in operation S201, when the sponsored tag setting method is the sponsor single matching method, the sponsor match advertisement service system 200 receives a keyword for a single advertisement keyword search from the service user 120 in operation S212. In operation S212, the service user 120 inputs a random keyword and requests a search to retrieve advertising information of a particular sponsor which is highly related to or identical to the corresponding content in the advertising information database 211.

In operation S213, the sponsor match advertisement service system 200 provides the service user 120 with an advertising information selection list including the received keyword. In operation S213, the sponsor match advertisement service system 200 searches a sponsor name table of a sponsor information list and an advertisement keyword table, title table, and content table of an advertising information list for all advertising information including a corresponding keyword. The sponsor information list is illustrated in FIG. 3A and stored in the advertising information database 211, and the advertising information list is illustrated in FIG. 3B. Also, the sponsor match advertisement service system 200 extracts an advertising information keyword query result, and provides the service user 120 with an advertising information selection list (UI 220 of FIG. 5B) via the user interface 220.

In operation S214, the sponsor match advertisement service system 200 receives a selection of advertising information (UI 221 of FIG. 5B) associated with the content from among the advertising information selection list (UI 220 of FIG. 5B) from the service user 120. In operation S214, when advertising information desired by the service user 120 is not included in the advertising information selection list (UI 220 of FIG. 5B) or a content corresponding to the advertising information selection list (UI 220 of FIG. 5B) does not exist, the sponsor match advertisement service system 200 may receive a cancel request of the advertising information from the service user 120 and may return to operation S212 or finish operation S214.

In operation S215, the sponsor match advertisement service system 200 directly maps the title of the advertising information selected in operation S214 to the sponsored tag, and generates a new sponsored tag by storing an advertising information identifier of the advertising information along with the sponsored tag. In operation S215, the sponsor match advertisement service system 200 enables the service user 120 to determine that the new sponsored tag is generated by exposing the new sponsored tag via the user interface 220. Accordingly, when clicking the new sponsored tag on the user interface 220, the service user 120 may confirm advertising information corresponding to the sponsored tag which is set by the service user 120 again. Also, in operation S215, when the service user 120 is unsatisfied with the set sponsored tag, the sponsor match advertisement service system 200 receives a cancel request of the sponsored tag setting from the service user 120 and may cancel and reset the sponsored tag.

In operation S216, the sponsor match advertisement service system 200 receives detailed path information (UI 209 of FIG. 5B) of an advertisement website from the service user 120. The detailed path information (UI 209 of FIG. 5B) of the advertisement website corresponds to sub-URL information which enables the service user 120 to access to a particular sub page of the advertisement website. In operation S216, when the service user 120 desires to provide more detailed advertising information, that is, when it is required to directly access to the particular sub page of the advertisement website, the sponsor match advertisement service system 200 receives the detailed path information.

In operation S217, the sponsor match advertisement service system 200 determines whether an additional setting request of sponsored tag or content registration request is received from the service user 120.

As a result of the determining in operation S217, when the additional setting request of sponsored tag is received from the service user 120, that is, when the service user 120 requests the additional setting by using an input device of a user terminal 125 to locate an input command cursor on a search input window and setting at least one sponsored tag, the sponsor match advertisement service system 200 receives the request and returns to operation S202. The search input window may set an additional sponsored tag.

As a result of the determining in operation S217, when the content registration request is received from the service user 120, the sponsor match advertisement service system 200 performs the above-described operations S207 and S208.

Referring again to FIG. 4A, in operation S130, the sponsor match advertisement service system 200 receives a content view request of the service visitor 130 and provides the service visitor 130 with content information and at least one sponsored tag associated with the content information via the visitor interface 240. In operation S1130, the sponsor match advertisement service system 200 retrieves the content information and sponsored tag-related information from the content information database 213. The content information and sponsored tag-related information corresponds to a content identifier included in the content view request received when displaying the sponsored tag. Also, in operation S130, the sponsor match advertisement service system 200 estimates a reliability index of the sponsored tag using information required to estimate the reliability index of the sponsored tag from among the extracted content information and sponsored tag-related information. Also, the sponsor match advertisement service system 200 provides a ranking to the estimated reliability index according to a predetermined ranking standard, and provides the service visitor 130 with the content information and the sponsored tag-related information via the visitor interface 240.

FIG. 4C is a flowchart illustrating an operation of displaying a content and a sponsored tag associated with the content according to an embodiment of the present invention.

Referring to FIG. 4C, in operation S300, a sponsor match advertisement service system 200 receives a content view request with respect to a particular content via an user interface 220 from a service user 120. Operation S300 is performed when the service user 120 clicks, while viewing a brief content information list via the user interface 220, brief information of a corresponding content to view detailed information of a particular content.

In operation S301, the sponsor match advertisement service system 200 estimates a sponsor match reliability index of the sponsored tag associated with the content and provides a ranking to the estimated index. In operation S301, the sponsor match advertisement service system 200 retrieves content information and sponsored tag-related information from the content information database 213. The content information and sponsored tag-related information corresponds to a content identifier included in the received content view request. Also, in operation S301, the sponsor match advertisement service system 200 estimates the sponsor match reliability index of the sponsored tag using information required to estimate the sponsor match reliability index from among the retrieved content information and sponsored tag-related information. Also, the sponsor match advertisement service system 200 provides a ranking to the estimated index according to a predetermined ranking standard.

The method of estimating the sponsor match reliability index of the sponsored tag and method of providing the ranking have been described when a sponsored tag display unit 250 is described.

In operation S302, the sponsor match advertisement service system 200 divides the ranked sponsored tag and displays the sponsored tag via the user interface 220. As an example of the displaying of the sponsored tag, in operation S302, a character color of the sponsored tag is displayed differently according to a ranking standard.

Thus, according to the present invention, the service visitor 130 may ascertain a level of association between the content and mapped advertising information using the character color of the sponsored tag prior to acquiring the advertising information when clicking the sponsored tag. Thus, the sponsor match advertisement service system 200 may improve a reliability of advertising information for the service visitor 130 and the sponsor 110, and may match a reliable advertisement more actively for the service user 120.

Referring again to FIG. 4A, in operation S140, the sponsor match advertisement service system 200 provides the service visitor 130 with an advertisement result list corresponding to the clicked sponsored tag in response to a particular sponsored tag click request of the service visitor 130.

FIG. 4E is a flowchart illustrating an operation of providing an advertisement result list according to the present invention.

In operation S400, a sponsor match advertisement service system 200 receives a sponsored tag click request associated with a particular content via a visitor interface 240 from a service visitor 130.

In operation S401, the sponsor match advertisement service system 200 retrieves sponsored tag setting identifier information of the clicked sponsored tag. In operation S401, a content identifier associated with the clicked sponsored tag is obtained by referring to the content information database 213 and thus the sponsored tag setting identifier information may be retrieved.

In operation S402, the sponsor match advertisement service system 200 determines whether a sponsored tag setting identifier of the extracted sponsored tag is a sponsor group matching method or sponsor single matching method. Operation S402 is performed to differently extract the advertisement result list according to the sponsored tag setting identifier which stores information about the sponsored tag setting method.

As a result of the determining in operation S402, when the sponsored tag setting identifier is the sponsor group matching method, the sponsor match advertisement service system 200 retrieves all advertising information corresponding to the sponsored tag. In this instance, all the advertising information including an advertisement keyword identical to the sponsored tag is retrieved by referring to the advertising information database 211.

In operation S405, the sponsor match advertisement service system 200 generates an advertisement result list from the retrieved advertising information according to a predetermined advertising information list generation standard. In operation S405, the sponsor match advertisement service system 200 realigns the retrieved advertising information list in an order of highest cost per an advertisement keyword click. Also, the advertisement result list is generated by assigning a predetermine number of advertisements from the realigned advertising information list in an order of highest priority.

In operation S406, the sponsor match advertisement service system 200 provides the service visitor 130 with the generated advertisement result list via the visitor interface 240.

As a result of the determining in operation S402, when the sponsored tag setting identifier is the sponsor single matching method, the sponsor match advertisement service system 200 retrieves advertising information corresponding to the sponsored tag. In operation S410, advertising information of a corresponding advertising information identifier is retrieved by acquiring the advertising information identifier corresponding to the sponsored tag by referring to the content information database 213.

Then, the sponsor match advertisement service system 200 performs operation S406 as described above.

Referring again to FIG. 4A, in operation S150, the sponsor match advertisement service system 200 receives and stores recommendation or objection of the service visitor 130 with respect to the provided advertisement result list from the service visitor 130. In operation S150, after viewing advertising information about at least one advertisement, or an advertising information list on the advertisement result list, when the service visitor 130 selectively suggests an opinion of using a recommendation or objection button according to whether the service visitor 130 may be satisfied with desired advertising information, i.e. whether the advertising information on the advertisement result list is highly related to a corresponding content, the sponsor match advertisement service system 200 receives the opinion, and stores a number of clicks for recommendation and a number of clicks for objection with respect to the sponsored tag by including the opinion.

Thus, according to the present invention, when estimating the sponsor match reliability index of the sponsored tag, a visitor evaluation index using the number of clicks for recommendation and the number of clicks for objection with respect to the sponsored tag is taken into account. In this instance, the visitor evaluation index is obtained by dividing the number of clicks for recommendation by a summed value of the number of clicks for objection and the number of clicks for recommendation. Thus, sponsor match advertisement service system 200 may improve a reliability of advertising information for the service visitor 130 that desires to obtain advertising information through the sponsored tag click, and the sponsor 110 that desires to obtain revenue by providing the advertising information through the sponsored tag setting.

In operation S160, when the service visitor 130 selects particular advertising information from the provided advertisement result list, the sponsor match advertisement service system 200 enables the service visitor 130 to be connected to an advertisement website of the sponsor 110 corresponding to the particular advertising information, and processes a predetermined calculation. The predetermined calculation is required for an advertising cost calculation with respect to the sponsor 110 and advertising revenue calculation associated with the clicked advertisement with respect to the service user 120. In operation S160, the sponsor match advertisement service system 200 performs an inquiry with respect to a calculation information list of the calculation information database 214 and generation of the calculation information list, and maintains and stores required information for a calculation of the sponsor 110 and the service user 120. Also, the sponsor match advertisement service system 200 extracts advertising cost per click of the clicked advertising information. The sponsor match advertisement service system 200 deducts the extracted advertising cost per click from account information of the sponsor 110 corresponding to the advertising information, and sums calculation information of a corresponding service user 120 and a predetermined revenue according to a predetermined revenue distribution rate rule.

Components illustrated and described in the specification may be physically embodied as a single system or separate systems.

The above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

As described above, according to the present invention, when a service user registers a UCC, advertising information related to a particular service or product which is highly related to or identical to the content may be provided to a service visitor through a sponsor tagging method, that is, a sponsored tag setting which is directly mapped to particular advertising information. Also, when the service visitor clicks a sponsored tag displayed with the content, advertising information of a sponsor corresponding to the sponsored tag may be provided. Accordingly, a method and system for providing a sponsor match advertisement service may be applied to a multimedia-based UCC such as a video where a conventional content matching advertisement service may not be applied using a keyword or context extraction engine, and may create a sponsorship marketing effect of sponsor based on participation of the service user.

Also, according to the present invention, advertising information related to a particular service or product, which is highly related to or identical to a content, may match advertising information associated with a particular brand, product, and service, which are more specific than a category. Also, advertising information of a particular sponsor may match a corresponding content. Also, in addition to an access to a main page, that is, an access to a main URL of an advertisement website registered by a sponsor, a direct access to a sub page including information about a particular product is available. Thus, a method and system for providing a sponsor match advertisement service may provide efficient advertising effect to the sponsor or service visitor.

Also, according to the present invention, a reliability of a sponsored tag which is set by a service user in association with a content, that is, a level of association between the content and advertising information, is estimated in various ways. Also, a service visitor may previously ascertain information when the service visitor obtains advertising information through a sponsored tag click, by differentiating an exposure method of the sponsored tag. Also, a service user may set advertising information highly related to the content, and thus the advertising information may not be spam advertising information. Thus, a method and system for providing a sponsor match advertisement service may enable more reliable advertising information to be matched.

Also, according to the present invention, a method and system for providing a sponsor match advertisement service may enable an advertisement keyword which is highly related to or identical to a content to be selected by providing an advertisement result list corresponding to an inputted advertisement keyword when setting a sponsored tag associated with the content.

Also, according to the present invention, a method and system for providing a sponsor match advertisement service may reduce an aversion to an advertisement exposure in comparison to a direct advertisement exposure by providing an indirect advertisement exposure method which exposes advertising information such as a title, content, and URL, of a corresponding sponsor when a sponsored tag is clicked.

Also, according to the present invention, a method and system for providing a sponsor match advertisement service may provide advertising information by selecting a sponsored tag appealing to a service visitor from a plurality of set sponsored tags, and thus a purchase intention and interest of a service visitor are taken into account, and a purchase conversion rate may be improved.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of providing an Internet advertisement associated with an Internet content, the method comprising:
maintaining a database which stores user information of a service user, at least one content uploaded by the service user, and a sponsored tag corresponding to the at least one content;
receiving a predetermined content from the service user;
receiving a sponsored tag corresponding to the content from the service user;
storing the sponsored tag and the content received in the database; and
providing a service visitor with predetermined advertising information corresponding to the sponsored tag, when receiving an input with respect to the sponsored tag from the service visitor viewing the content.

2. The method of claim 1, wherein the receiving of the sponsored tag comprises:
receiving a keyword for an advertisement keyword search from the service user;
retrieving an advertisement keyword corresponding to the keyword by referring to a predetermined advertising information database, and providing the service user with the retrieved advertisement keyword;
receiving a selection of the service user with respect to the advertisement keyword; and
registering the selected advertisement keyword as the sponsored tag.

3. The method of claim 2, wherein the providing of the retrieved advertisement keyword comprises:
retrieving information of advertising cost with respect to the retrieved advertisement keyword by referring to the advertising information database; and
sorting the advertisement keyword based on the advertising cost.

4. The method of claim 1, wherein the receiving of the sponsored tag comprises:
receiving a keyword for an advertisement keyword search from the service user;
providing the service user with an advertising information selection list including the keyword by referring to a predetermined advertising information database;
receiving a selection of the service user with respect to the advertising information selection list; and
registering the selected advertising information as the sponsored tag.

5. The method of claim 4, wherein the registering comprises:
retrieving an advertising information identifier corresponding to the selected advertising information by referring to the advertising information database; and
receiving Uniform Resource Locator (URL) information corresponding to the advertising information identifier, and storing the URL information in the database in association with the sponsored tag.

6. The method of claim 4, wherein the providing of the advertising information selection list comprises:
retrieving advertising cost information with respect to the selected advertising information by referring to the advertising information database; and
sorting the advertising information based on an advertising cost.

7. The method of claim 1, wherein:
the receiving of the content comprises:
receiving the tag information with respect to the content from the service user, and
the method further comprises:
comparing tag information and keyword information of the sponsored tag, the tag information corresponding to at least one tag information with respect to the content; and
increasing a content matching index value with respect to the sponsored tag stored in the database, when the tag information matches the keyword information.

8. The method of claim 1, wherein the providing of the advertising information comprises:
providing the service visitor viewing the advertising information with a user interface inquiring about a validity of the advertising information; and
increasing a reliability index data value with respect to the sponsored tag stored in the database according to data inputted by the service visitor.

9. The method of claim 1, wherein the database further comprises a reliability index data value field with respect to the sponsored tag, and the reliability index data value is estimated by taking into account at least one of a content matching index value computed with respect to the sponsored tag, an advertising effect index, and a visitor evaluation index, the advertising effect index being defined as a ratio of a page view with respect to the content to a number of clicks on the sponsored tag corresponding to the content, and the visitor evaluation index being defined as feedback data of the service visitor with respect to the sponsored tag.

10. The method of claim 1, further comprising:
maintaining a calculation information database which stores calculation information with respect to a sponsor of the advertising information and the service user; and
updating the calculation information according to a predetermined advertising cost calculation rule, and storing the updated calculation information in the calculation information database when the service visitor clicks the sponsored tag.

11. A computer-readable recording medium storing a program for implementing a method of providing an Internet advertisement associated with an Internet content, the method comprising:
maintaining a database which stores user information of a service user, at least one content uploaded by the service user, and a sponsored tag corresponding to the at least one content;
receiving a predetermined content from the service user;
receiving a sponsored tag corresponding to the content from the service user;
storing the sponsored tag and the content received in the database; and
providing a service visitor with predetermined advertising information corresponding to the sponsored tag, when receiving the sponsored tag from the service visitor viewing the content.

12. A system for providing an Internet advertisement associated with an Internet content, the system comprising:
a database which stores user information of a service user, at least one content uploaded by the service user, and a sponsored tag corresponding to the at least one content;
a database management unit which stores a predetermined content and the sponsored tag in the database, the content being received from the service user, and the sponsored tag corresponding to the content inputted by the service user; and
an advertisement providing unit which provides a service visitor with predetermined advertising information corresponding to the sponsored tag, when receiving the sponsored tag from the service visitor viewing the content.

13. The system of claim 12, wherein the database further comprises a reliability index data value field with respect to the sponsored tag, and the reliability index data value is estimated by taking into account at least one of a content matching index value computed with respect to the sponsored tag, an advertising effect index, and a visitor evaluation index, the advertising effect index being defined as a ratio of a page view with respect to the content to a number of clicks on the sponsored tag corresponding to the content, the visitor evaluation index being defined as feedback data of the service visitor with respect to the sponsored tag.

14. The system of claim 12, further comprising:
a calculation information database which stores calculation information with respect to a sponsor of the advertising information and the service user,
wherein the database management unit updates the calculation information according to a predetermined advertising cost calculation rule, and stores the updated calculation information in the calculation information database when the service visitor clicks the sponsored tag.
